(19) United States
(12) Patent Application Publication
(10) Pub. No.: US 2022/0250308 A1
(43) Pub. Date: Aug. 11, 2022

(54) METHODS FOR MANUFACTURING WIND TURBINE BLADES AND LEADING EDGE PROTECTION SURFACES

(71) Applicant: PPG Coatings Europe B.V., Amsterdam (NL)

(72) Inventors: Kerianne Dobosz, Pittsburgh, PA (US); Cynthia Kutchko, Plum, PA (US); Renhe Lin, Stevenson Ranch, CA (US); Ali Shah, Pittsburgh, PA (US); Maria Helena Angelina Van Der Linden, Nieuw-Vennep (NL); Bryan W. Wilkinson, Pittsburgh, PA (US); Chimming Hui, Pittsburgh, PA (US); Eric Epstein, Pittsburgh, PA (US)

(73) Assignee: PPG Coatings Europe B.V., Amsterdam (NL)

(21) Appl. No.: 17/622,726

(22) PCT Filed: Jun. 25, 2020
(86) PCT No.: PCT/US2020/039557

§ 371 Date: Dec. 24, 2021

Related U.S. Application Data
(60) Provisional application No. 62/866,486, filed on Jun. 25, 2019.

(51) Int. Cl. B29C 64/106; F03D 1/06; B33Y 10/00; B33Y 40/10; B33Y 80/00; B29C 64/314

(52) U.S. Cl. CPC B29C 64/106; F03D 1/0675; B33Y 10/00; B33Y 40/10; B29K 2101/10; B29C 64/314; F05B 2230/24; F05B 2240/303; B33Y 80/00

(57) ABSTRACT

Methods of fabricating wind turbine blades, leading edge protection surfaces of wind turbine blades and wind turbine protection shields using coreactive additive manufacturing. The blades, surfaces (605), and protection shields can include a single layer or multiple layers of a cured composition applied using coreactive manufacturing such as three-dimensional printing. Methods of repairing leading edge (601) surfaces of wind turbine blades include applying one or more layers of a coreactive composition onto the damaged leading edge surfaces using coreactive additive manufacturing or applying a leading edge protection shield onto a damaged leading edge (601) of a wind turbine blade.

### FIELD

The disclosure relates to materials and method for manufacturing wind turbine blades. Wind turbine blades, portions of wind turbine blades, and parts used to prepare wind turbine blades can be formed by coextruding coreactive compositions using additive manufacturing methods. The materials used to form the wind turbine blades can be selected to meet demanding performance requirements. The materials and methods can be used to fabricate wind turbine leading edge protection shields.

### BACKGROUND

Wind turbine blades must meet demanding performance requirements. A new wind turbine blade presents an aerodynamically smooth surface. However, within from two to three years of operation, the leading edge of a wind turbine blade can become severely eroded as a result of impact, for example, by water droplets, ice, particulates, snow, hail, and insects. The eroded surface can also enhance ice accumulation. These effects compromise the optimal aerodynamic profile of the wind turbine blade, which results in a significant decrease in wind power conversion efficiency.

### SUMMARY

According the present invention, methods of fabricating at least a portion of a wind turbine blade comprise using coreactive additive manufacturing.

According to the present invention, wind turbine blades, leading edge surfaces, and leading edge protection shields are fabricated using coreactive additive manufacturing.

### BRIEF DESCRIPTION OF THE DRAWINGS

The drawings described herein are for illustration purposes only. The drawings are not intended to limit the scope of the present disclosure.

FIG. 1 shows a cross-sectional view of a multilayer structure with layers having uniform compositions according to the present disclosure.

FIG. 2 shows a cross-sectional view of a multilayer structure having a continuous horizontally structured layer (202), a continuous vertically structured layer (204), and a non-structured layer (203) according to the present disclosure.

FIG. 3 shows a cross-sectional view of a multilayer coating having discontinuous structured layers.

FIG. 4 shows a cross-sectional view of a multilayer coating having discrete internal structures.

FIGS. 5A-5C show cross-sectional views of adjoining layers having structured interfaces.

FIG. 6 shows a perspective view of a portion of a wind turbine blade.

### DETAILED DESCRIPTION

For purposes of the following detailed description, it is to be understood that embodiments provided by the present disclosure may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

The expression “at least one or more” as in “at least one or more layers” means one or more than one such as 2, 3, 4, 5, 6, 7, 8, 9, or 10. For example, the expression “at least one or more” can mean from 1 to 10, from 1 to 9, from 1 to 8, from 1 to 7, from 1 to 6, from 1 to 5, from 1 to 4, from 1 to 3, or from 1 to 2.

“Prepolymer” includes homopolymers and copolymers. For thiol-terminated prepolymers, molecular weights are number average molecular weights “Mn” as determined by end group analysis using iodine titration. For prepolymers that are not thiol-terminated, the number average molecular weights are determined by gel permeation chromatography using polystyrene standards. A prepolymer comprises reactive groups capable of reacting with another compound such as a curing agent or crosslinker to form a cured polymer. A prepolymer includes multiple repeating subunits bonded to each other than can be the same or different. The multiple repeating subunits make up the backbone of the prepolymer.

“Coreactive composition” refers to a composition comprising at least two reactive compounds capable of reacting with each other. A coreactive composition refers to a composition comprising two or more coreactive compounds capable of reacting at a temperature, for example, less than 50° C., less than 40° C., less than 30° C., or less than 20° C. The reaction between the two or more reactive compounds may be initiated by combining and mixing the two or more coreactive compounds, by adding a catalyst to a coreactive composition comprising two or more coreactive compounds and/or by activating a polymerization initiator in a coreactive composition comprising the two or more coreactive compounds. A coreactive composition can be formed, for example, by combining and mixing a first reactive component comprising a first reactive compound with a second reactive component comprising a second reactive compound, wherein the first reactive compound can react with the second reactive compound. A coreactive composition can be a thermosetting composition and when cured forms a thermoset.

“Extrudate” refers to a coreactive composition that have been extruded through a nozzle or extrusion die. A coextrudate refers to two or more coreactive compositions that have been simultaneously extruded through a nozzle or coextrusion die.

“Formed from” or “prepared from” denotes open, e.g., comprising, claim language. As such, it is intended that a composition “formed from” or “prepared from” a list of recited components be a composition comprising at least the recited components or the reaction product of at least the recited components, and can further comprise other, non-recited components used to form or prepare the composition.

“Fracture energy” is determined according to ASTM D7313.

Glass transition temperature T_{g} is determined by dynamic mechanical analysis (DMA) using a TA Instruments Q800 apparatus with a frequency of 1 Hz, an amplitude of 20 microns, and a temperature ramp of −80° C. to 25° C., with the T_{g} identified as the peak of the tan δ curve.

“Thermoset” refers to a cured thermosetting polymer composition.

“Thermosetting composition” refers to a composition comprising coreactive compounds that change irreversibly into an infusible, insoluble polymer network by curing. Curing is the chemical process of converting a prepolymer and curing agents into a polymer of higher molecular weight and then into a polymer network. Curing results in chemical reactions that create extensive cross-linking between A polymer network is a highly ramified structure in which essentially each constitutional unit is connected to each other constitutional unit and to the macroscopic phase boundary by many paths through the structure, the number of such paths increasing with the average number of intervening constitutional units; the paths must on average co-extensive with the structure.

“Longitudinal dimension” of a wind turbine blade refers to the length dimension extending from the nacelle to the tip of the wind turbine blade.

“Width dimension” of a wind turbine blade refers to the dimension orthogonal to the length of a wind turbine blade and extends from the leading edge to the trailing-edge of the wind turbine blade.

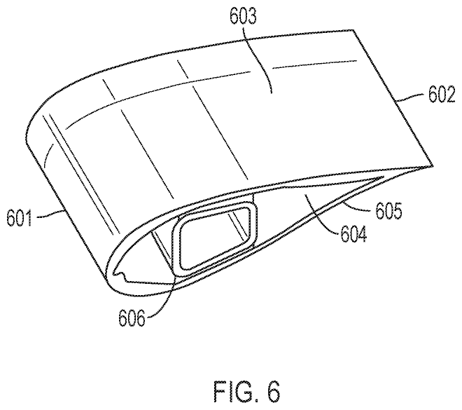

“Leading edge” of a wind turbine blade refers to the edge facing toward the direction of the wind and away from the nacelle. FIG. 6 shows a view of a portion of a wind turbine blade including the leading edge 601, the trailing edge 602, the downwind side surface 603, the upwind side surface 605, the aerodynamic shell 604, and a load carrying structure 606. Any of these parts of the wind turbine blade can be fabricated using coreactive additive manufacturing methods provided by the present disclosure.

“Structured layer” refers to a material layer in which the composition throughout the layer is not uniform or homogeneous. One or more constituents of a composition forming a layer can vary in type or concentration can vary within a layer. The type and or concentration of the one or more constituents can vary within the thickness of a layer and/or within the plane of a layer and can vary continuously and/or discretely within one or more dimensions of a layer. The multiple compositions forming a structured layer can impart different properties to different portions of the structured layer.

“Extrusion nozzle assembly” refers to the exit assembly of a reactive extrusion additive manufacturing apparatus. The nozzle assembly includes elements configured to shape one or more coreactive compositions, merge one or more coreactive compositions, and/or tailor one or more coreactive compositions and an exit orifice. A nozzle assembly can include robotically and/or manually adjustable elements. A nozzle assembly can include elements that control and/or tailor the flow of the one or more coreactive compositions through the nozzle assembly. For example, the nozzle assembly can be configured to provide for laminar flow of the one or more coreactive compositions. A nozzle assembly can be similar to an extrusion die used in thermoplastic extrusion and include similar design features used to manufacture articles using thermoplastic extrusion. However, thermoplastic extrusion dies are typically designed to withstand the high temperatures and pressures used in the thermoplastic extrusion process. Because the coreactive compositions used in reactive extrusion have a low viscosity and can be extruded at ambient temperature such as from 20° C. to 30° C., the materials used to form a reactive extrusion nozzle assembly can be different than for a thermoplastic extrusion die, although many of the design elements can be similar.

Reference is now made to certain compounds, compositions, and methods of the present invention. The disclosed compounds, compositions, and methods are not intended to be limiting of the claims. To the contrary, the claims are intended to cover all alternatives, modifications, and equivalents.

A wind turbine blade and the leading edge of a wind-turbine blade has a carefully designed predetermined shape. Large wind turbine blades rotate with very high tip speeds, sometimes in excess of 100 m/sec. Over time, this causes very severe erosion and impact damage conditions, particularly along the outer third or half of the blade leading edge, closest to the tip.

The leading edge of a wind turbine blade can be damaged as the result of high velocity impact with rain droplets, ice, snow, hail, particulates, and insects. Damaged wind turbine blades are difficult to repair while mounted on the turbine.

Wind turbine blades or portions of wind turbine blades can be fabricated using a single layer or multiple layers of extruded and/or coextruded coreactive compositions. Coextruded single or multilayer articles provided by the present disclosure can exhibit improved performance properties suitable for wind turbine blade applications. The articles can be integrated into wind turbine blades during manufacturing, applied to new wind turbine blades as, for example, leading edge protection shields, or provided as replacement or repair parts. For example, leading edge protection shields can be applied to damaged wind turbine blades to restore the intended aerodynamic performance and recover the wind conversion energy efficiency.

The use of coreactive thermoset chemistries and ambient coreactive additive manufacturing methods facilitate the ability to use a wide variety of materials and incorporate structural design elements that facilitate the ability to fabricate articles that exhibit enhanced performance in wind turbine blade applications.

Articles provided by the present disclosure can be fabricated using ambient coreactive additive manufacturing technology. The multilayer articles can be fabricated by coextruding one or more coreactive compositions or by sequentially extruding individual layers having different compositions. The coextruded/extruded articles can include one or more interior layers and an exterior layer. Each of the one or more interior layers can independently comprise an interior coreactive composition, and the exterior layer can comprise an exterior coreactive composition.

Multilayer articles provided by the present disclosure can be used to fabricate wind turbine blades, portions of wind turbine blades, the exterior surface or a portion of the exterior surface of wind turbine blades, or articles used to repair wind turbine blades such as leading edge protection shields.

Articles provided by the present disclosure can also include a single layer. The composition of the layer can be uniform or homogeneous throughout the layer. The composition of the layer can vary across the thickness of the single layer and/or within the plane of the layer. In a multilayer article, different coreactive compositions can be combined in a coextrusion nozzle to maintain a substantially discrete multilayer structure although some mixing at the interface between adjoining layers can occur. As a single layer article, the constituents of a coreactive composition can be continuously and/or discontinuously changed during the extrusion process through a single die and/or the constituents can be combined in the ambient coreactive additive manufacturing apparatus such that the coreactive composition varies across the thickness of the extruded layer and/or within the plane of the extruded layer either continuously or discontinuously. In a single-layer article the composition of the single layer can be inhomogeneous within the thickness of the layer and/or within the plane of the layer.

Articles provided by the present disclosure can be fabricated using reactive additive manufacturing. Reactive additive manufacturing employing extrusion technologies facilitate the ability to fabricate single and multilayer articles using a wide variety of coreactive thermosetting compositions and having a wide range of compositionally defined structures.

Articles provided by the present disclosure can comprise one or more layers.

Each of the layers and/or each portion of a layer can be configured to impart a different property to a portion of a layer, to the layer as a whole, and/or to the multilayer article.

A multilayer article can include, for example, an exterior layer, one or more interior layers, and an inner layer.

An inner layer can be an adhesive layer configured to promote adhesion to the surface of a wind turbine blade. The adhesive layer can be integrated into the multilayer article during coextrusion and/or can be applied as a separate coating layer to either the multilayer coating and/or to the wind turbine blade.

An inner layer can be a structural element. For example, an inner layer can comprise a rigid substrate. A rigid substrate can comprise reinforcing material such as fiberglass. An inner structural layer can be coextruded with other layers. For example, a structural layer can be extruded with one or more additional layers where the one or more additional layers are toward the outer surface of a article such as a wind turbine blade. An inner layer such as an inner structural layer can be formed in a separate process using any suitable technology such as ambient reactive extrusion with additive manufacturing methods, compression molding, compression molding, or thermoforming. Exterior layers can be applied to the inner structural layer or substrate using coreactive additive manufacturing methods provided by the present disclosure.

An exterior layer, a portion of the exterior layer, the surface of the exterior layer, or a portion of the exterior surface, can be configured to protect the leading edge of a wind turbine blade from damage caused by rain, ice, hail, and particulates, mitigate ice buildup, and/or mitigate accumulation of debris.

An exterior layer can be configured to cause rain droplets to bounce from the surface and to deflect particulates. Surfaces that are smooth and hydrophobic can mitigate ice buildup and accumulation of insect debris. These objectives can be achieved by designing an exterior coating to have a low surface roughness, to have a low drag resistance, to have a low surface energy, and to be elastic.

An exterior layer, such as an exterior layer of a wind turbine blade, a leading edge of a wind turbine blade, or a leading edge protection shield can have a thickness, for example, less than 3 mm, less than 2 mm, less than 1 mm, or less than 0.5 mm. An exterior layer can have a thickness, for example, greater than 0.2 mm, greater than 0.5 mm, greater than 1 mm, greater than 2 mm, or greater than 3 mm. An exterior layer can have a thickness, for example, from 0.2 mm to 3 mm, from 0.5 mm to 2.5 mm, or from 0.5 mm to 2 mm.

A surface of an exterior layer can have a surface roughness (Rₐ), for example, less than 10 μm, less than 8 μm, less than 6 μm, less than 4 μm, less than 2 μm, less than 1 μm, less than 0.3 μm, less than 0.2 μm, or less than 0.1 μm, as measured using a Taylor Hobson Precision Surtronic Duo profilometer following the instruction described in the Taylor Hobson Precision Surtronic Duo Manual (surface roughness test).The surface can be aerodynamically smooth such that there is laminar flow across the surface of the wind turbine blade at operating conditions. An exterior layer can have a surface roughness (Rₐ), for example, from 0.05 μm to 0.3 μm, from 0.1 μm to 0.3 μm, from 0.2 μm to 0.3 μm, from 1 μm to 10 μm, from 1 μm to 8 μm, from 1 μm to 6 μm, from 1 μm to 4 μm, or from 1 μm to 3 μm, as measured using a Taylor Hobson Precision Surtronic Duo profilometer following the instruction described in the Taylor Hobson Precision Surtronic Duo Manual (surface roughness test).

An exterior layer can have a gloss value (GU), for example, less than 90 GU, less than 80 GU, less than 70 GU, or less than 60 GU, at 60°, determined according to ISO 2813. An exterior layer can have a gloss value (GU)), for example, from 50 GU to 90 GU, from 60 GU to 90 GU, or from 70 GU to 90 GU, at 60°, determined according to ISO 2813.

An exterior layer can have a water contact angle, for example, greater than 90°, greater than 95°, greater than 100°, greater than 105°, greater than 110°, or greater than 120°, where the water contact angle is determined using a drop shape analyzer as described in Example 2. An exterior layer can have a water contact angle, for example, from 90° to 120°, from 90° to 110°, or from 95° to 110°.

An exterior layer can have a diiodomethane contact angle, for example, greater than 50°, greater than 60°, greater than 70°, greater than 75°, greater than 80°, greater than 85°, greater than 90°, or greater than 100°, where the diiodomethane contact angle is determined using a drop shape analyzer as described in Example 2. An exterior layer can have a diiodomethane contact angle, for example, from 50° to 100°, from 60° to 100°, from 70° to 100°, from 75° to 110°, or from 80° to 90°.

An exterior layer can have a surface free energy, for example, less than 50 mN/m, less than 40 mN/m, less than 30 mN/m, or less than 20 mN/m, where the surface free energy is determined using a drop shape analyzer. An exterior layer can have a surface free energy, for example, from 1 mN/m to 50 mN/m, from 1 mN/m to 40 mN/m, or from 1 mN/m to 30 mN/m, where the surface free energy is determined using a drop shape analyzer.

An exterior layer can have a tan δ from 10 to 100, determined using an Anton Paar MCR 301 or 302 rheometer with a gap set to 1 mm, with a 25 mm-diameter parallel plate spindle, and an oscillation frequency of 1 Hz and amplitude of 0.3% at 25° C.

An exterior layer can have an impact force resistance, for example, greater than 70 inch-lb (7.91 N-m), greater than 80 inch-lb (9.0 N-m), greater than 90 inch-lb (10.16 N-m), or greater than 100 inch-lb (11.29 N-m), as determined according to ASTM D2794. An exterior layer can have an impact force resistance, for example, from 70 inch-lb to 100 inch-lb (7.91 N-m to 11.29 N-m), from 75 inch-lb to 95 inch-lb (8,47 N-m 10.73 N-m), or from 85 inch-lb to 95 inch-lb (9.61 N-m to 10.73 N-m), as determined according to ASTM D2794.

An exterior layer can have an abrasion weight loss, for example, of less than 100 mg, less than 80 mg, or less than 60 mg, determined according to modified ASTM D4060 as described in Example 2.

An exterior layer can have a surface hardness, for example, from Shore 10A to Shore 60A, determined using a Type A durometer in accordance with ASTM D2240.

An exterior layer can have a tensile strength, for example, greater than 1 MPa, greater than 5 MPa, greater than 10 MPa, greater than 15 MPa, greater than 20 MPa, or greater than 25 MPa, determined according to ASTM D638. An exterior layer can have a tensile strength, for example, from 1 MPa to 30 MPa, from 1 MPa to 25 MPa, from 5 MPa to 20 MPa, from 10 MPa to 20 MPa, or from 15 MPa to 20 MPa, determined according to ASTM D638.

An exterior layer can have a tensile elongation, for example, greater than 400%, greater than 500%, greater than 600%, greater than 800%, or greater than 1,000%, at 400 mm/min, determined according to ASTM D638. An exterior layer can have a tensile elongation, for example, from 400% to 1,200%, from 500% to 1,100%, from 600% to 1,000%, from 400% to 700%, from 400% to 600%, or from 400% to 500%, determined according to ASTM D638.

An exterior layer can have a tensile Young's modulus, for example, greater than 1 MPa, greater than 5 MPa, greater than 10 MPa, greater than 20 MPa, greater than 30 MPa, or greater than 40 MPa, where the tensile Young's modulus is determined according to ASTM D638. An exterior layer can have a tensile Young's modulus, for example, from 1 MPa to 50 MPa, from 5 MPa to 45 MPa, or from 10 MPa to 40 MPa.

An exterior layer can have a tension mode storage modulus greater than 1 MPa, greater than 5 MPa, greater than 10 MPa, greater than 15 MPa, greater than 20 MPa, greater than 30 MPa, greater than 40 MPa, greater than 50 MPa, greater than 100 MPa, or greater than 150 MPa, where the tension mode storage modulus is determined at 25° C. and 100 MHz. An exterior layer can have a tension mode storage modulus, for example, from 1 MPa to 200 MPa, from 1 MPa, to 150 MPa, from 1 MPa to 100 MPa, from 1 MPa to 50 MPa, from 5 MPa to 45 MPa, or from 10 MPa to 40 MPa, where the tension mode storage modulus is determined at 25° C. and 100 MHz. An exterior layer can have a tension mode storage modulus, for example, less than 200 MPa, less than 150 MPa, less than 100 MPa, or less than 50 MPa, where the tension mode storage modulus is determined at 25° C. and 100 MHz.

An exterior layer can have a tension mode storage modulus greater than 50 MPa, greater than 60 MPa, greater than 70 MPa, greater than 80 MPa, greater than 90 MPa, greater than 100 MPa, greater than 200 MPa, greater than 400 MPa, greater than 600 MPa, or greater than greater than 800 MPa, where the tension mode storage modulus is determined at -25° C. and 158 MHz. An exterior layer can have a tension mode storage modulus, for example, from 50 MPa, to 1,000 MPa, from 100 MPa, to 800 MPa, or from 200 MPa to 600 MPa, from 50 MPa to 120 MPa, from 60 MPa to 110 MPa, or from 60 MPa to 100 MPa, where the tension mode storage modulus is determined at −25° C. and 158 MHz. An exterior layer can have a tension mode storage modulus, for example, less than 1,000 MPa, less than 800 MPa, less than 600 MPa, less than 400 MPa, less than 200 MPa, or less than 100 MPa, where the tension mode storage modulus is determined at −25° C. and 158 MHz.

An exterior layer can have an impact resistance, for example, greater than 30 cm/kg, greater than 35 cm/kg, greater than 40 cm/kg, or greater than 45 cm/kg, determined according to ASTM D27694. An exterior layer can have an impact resistance, for example, from 30 cm/kg to 50 cm/kg, from 30 cm/kg to 45 cm/kg, or from 30 cm/kg to 40 cm/kg, determined according to ASTM D27694

An exterior layer can have a pull-off strength, for example, greater than 5 MPa, greater than 10 MPa, greater than 15 MPa, or greater than 20 MPa, determined according to ISO 4624. An exterior layer can have a pull-off strength, for example, from 5 MPa to 30 MPa, from 5 MPa to 25 MPa, or from 5 MPa to 20 MPa, determined according to ISO 4624.

An exterior layer can have a flexibility, for example, greater than 1 mm, greater than 2 mm, greater than 3 mm, or greater than 4 mm, determined according to ISO 1519. An exterior layer can have a flexibility, for example, from 1 mm to 5 mm, from 1 mm to 4 mm, or from 1 mm to 3 mm, determined according to ISO 1519.

An exterior layer can have a glass transition temperature T_{g}, for example, from −50° C. to 110° C., from −40° C. to 100° C., from −20° C. to 80° C., or from 0° C. to 50° C., as determined by Dynamic Mass Analysis (DMA) using a TA Instruments Q800 apparatus with a frequency of 1 Hz, an amplitude of 20 microns, with the Tg identified as the peak of the tan δ curve. An exterior layer can have a glass transition temperature T_{g}, for example, greater than −50° C., greater than −20° C., greater than 0° C., greater than 20° C., greater than 60° C., or greater than 100° C.

An exterior layer can have a glass transition temperature, for example, less than 0° C., less than −10° C., less than −20° C., less than −30° C. or less than −40° C., where the glass transition temperature is determined by dynamic mechanical analysis An exterior layer can have a glass transition temperature (Tg) from 0° C. to −50° C., from −10° C. to −45° C., or from −15° C. to −40° C.

An exterior layer can have a time to failure in the rain erosion test as described in Example 3, for example, of greater than 100 minutes, greater than 200 minutes, greater than 300 minutes, greater than 400 minutes, or greater than 500 minutes. An exterior layer can have a time to failure in the rain erosion test, for example, from 100 minutes to 600 minutes, from 150 minutes to 550 minutes, from 200 minutes to 500 minutes, or from 250 minutes to 450 minutes.

An exterior layer can have an RET greater than 5 hours determined according to DNVGL-RP-0171.

An exterior layer and a multilayer article such as a wind turbine blade or a wind turbine protection shield can meet the requirements of DNVGL-RP-0171, Edition February 2018 “Testing of rotor blade erosion protection systems.”

A cured exterior layer can exhibit one or more of the preceding properties.

The surface of a cured multilayer article such as a wind turbine blade, a leading edge of a wind turbine blade, or a wind turbine protection shield can exhibit one or more of the preceding properties.

An interior layer of a multilayer article can be a structural layer that provides sufficient mechanical integrity such that the multilayer article can be handled before the multilayer coating is completely cured. A structural interior layer can be a structural layer in addition to an inner structural layer. The structural elements of the multilayer article can comprise one or more layers.

An interior layer can be configured to modify a property of an overlying layer, an underlying layer and/or to impart one or more properties to the multilayer article as a whole. Individual layers of a multilayer article can be selected such that the properties of the article and/or a portion of an article such as the exterior of an article can exhibit properties resulting from the combination of layers.

An individual layer can have a thickness, for example, from 1 μm to 3,000 μm, from 100 μm to 3,000 μm, from 500 μm to 2,500 μm or from 1,000 μm to 2,000 μm. A layer can have a thickness, for example, greater than 1 μm, greater than 100 μm, greater than 500 μm, greater than 1,000 μm, or greater than 2,000 μm. A layer can have a thickness, for example, less than 4,000 μm, less than 3,000 μm, less than 2,000 μm, less than 1,000 μm, or less than 500 μm.

Each layer can independently have a thickness, for example, from 1 μm to 1,000 μm, from 10 μm to 1,000 μm, from 100 μm to 800 μm, or from 200 μm to 600 μm. Each layer can independently have a thickness, for example, greater than 1 μm, greater than 10 μm, greater than 100 μm, greater than 250 μm, greater than 500 μm, greater than 750 μm, or greater than 1,000 μm. A layer can have a thickness, for example, less than 10 μm, less than 100 μm, less than 250 μm, less than 500 μm, less than 750 μm, or less than 1,000 μm.

Layers, such as structural layers can have a thickness greater than 3,000 μm. Wind turbine blades can have a thickness that decreases from the nacelle toward the blade tip and from the leading edge to the trailing-edge.

The number of layers, the thickness of the layers, the configuration of the layers, and/or the materials forming the layers can be selected to optimize certain properties independently or in combination with other layers and/or the properties of the multilayer article as a whole.

A property of a layer may not necessarily be the same as the corresponding property of the multilayer article. For example, the hardness of an exterior layer refers to the hardness of the layer when measured independent of the other layers forming the multilayer article. The hardness of the multilayer article refers to the hardness of the multilayer article including all layers of the multilayer article. Depending on factors such as the composition and thickness of the individual layers, a property of the multilayer article may or may not be dominated by the corresponding property of the exterior layer or one or more of the interior layers.

A cured multilayer article provided by the present disclosure exhibit one or more of the preceding properties set for the exterior layer.

A thickness of a layer of a multilayer article can independently be selected to optimize one or more properties of the layer, the multilayer article, a wind turbine blade, and/or a wind turbine.

Each layer can independently have a uniform thickness or a non-uniform thickness throughout the plane of the layer.

A layer having a uniform thickness will have a substantially uniform thickness in the longitudinal dimension and in the orthogonal dimension.

A layer can have a non-uniform thickness such that the thickness varies in the longitudinal and/or orthogonal dimensions. The thickness of a layer can be selected to optimize a certain property at different longitudinal and/or orthogonal positions along a wind turbine blade. A thickness of a layer can decrease in the orthogonal dimension to facilitate the ability of the multilayer article to provide an aerodynamically smooth interface. For a wind turbine leading edge protection shield, the thickness of the shield can decrease in the orthogonal dimension such that when applied to a wind turbine blade, the trailing-edge of the shield conforms to the aerodynamic profile of the wind turbine blade and provides an aerodynamically smooth transition from the shield to the surface of the wind turbine blade.

A thickness of a layer can be selected to optimize the properties of the multilayer article at different positions along the blade and/or to optimize the performance of the wind turbine. For example, in part because the speed of a wind turbine blade is much higher toward the tip than at the nacelle, the damage caused by high velocity impact with rain droplets and particulates is much more severe toward the blade tip than at toward the nacelle. Single or multilayer articles or leading edge protection shields can be designed such that the properties toward the tip of a wind turbine blade are different than those toward the nacelle. For example, a portion of a single multilayer article situated toward the tip of a wind turbine blade can exhibit a high impact strength, Young's modulus, and/or a high tan δ. As another example, a single or multilayer article serving as a leading edge protection layer can be thicker toward the tip of the wind turbine blade.

A coreactive composition used to form a layer can include, for example, one or more coreactants and one or more additives. For an inhomogeneous layer, the type and/or concentration of the one or more coreactants and/or the one or more additives can be different in a different portion or in different portions of a layer.

A layer having an inhomogeneous coreactive composition in at least one dimension is referred to as a structured layer.

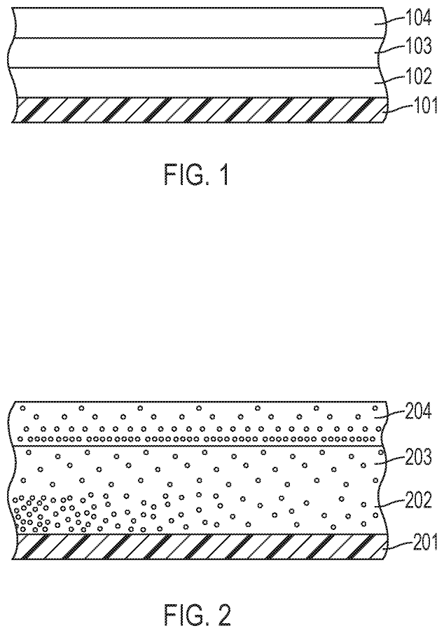

A layer having a homogeneous coreactive composition throughout the thickness and within the plane of the layer is referred to as a non-structured layer. FIG. 1 shows a multilayer article having three layers 102/103/104 having a uniform composition overlying a substrate 101.

In multilayer articles provided by the present disclosure, each layer can independently be a structured layer or non-structured layer.

A structured layer can be vertically structured and/or horizontally structured. A vertically structured layer refers to a layer in which the composition varies across or in a portion of the thickness of the layer. A horizontally structured layer refers to a layer in which the composition varies within the plane of the layer or a portion of the plane of the layer. A vertically and horizontally structured layer refers to a layer in which the composition varies across the layer thickness and within the plane of the layer, or across a portion of the layer thickness and within a portion of the plane of the layer

A horizontally structured layer can be structured in the longitudinal dimension and/or the orthogonal dimension. With respect to a wind turbine blade, a horizontally structured layer can comprise a composition that varies depending upon the distance from the turbine nacelle.

A structured layer can be continuously structured and/or discontinuously structured.

A continuously structured layer refers to a layer in which the composition within the layer varies vertically and/or horizontally in a continuous manner. For example, the concentration of one or more of the reactants and/or one or more of the additives can vary continuously.

The continuous variation can be linear, non-linear, or combination thereof.

FIG. 2 shows layer 204 in which a concentration of a constituent (represented by the circles) increase from the top to the bottom of the layer 204. In layer 203 the concentration of the constituent is substantially uniform throughout the layer 203. In layer 202, the concentration of the constituent decreases from left to right and is substantially uniform within the thickness of the layer. Layers 202/203/204 overlie layer 201, which can be a substrate or a structural layer of the multilayer article.

A discontinuously structured layer refers to a layer in which the coreactive composition varies discretely within the layer vertically and/or horizontally. For example, rather than having a concentration of a coreactant and/or additive vary continuously, a portion or portions of a layer can have a concentration of a reactant and/or additive that is dis-continuous such that a discrete interface is evident between the two compositions within a layer. For example, a discontinuously structured layer can have one or more regions having a different composition than other regions of the discontinuously structured layer. The discrete regions can, for example, span the thickness of a layer, span a portion of the thickness of a layer, or be embedded within a layer.

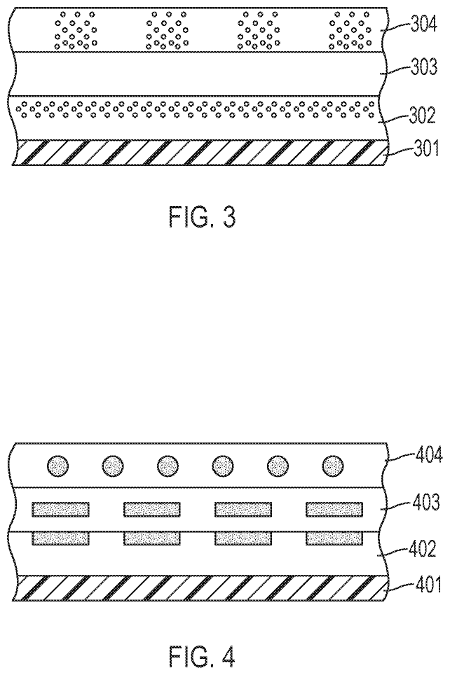

A discontinuously structured layer can be characterized by a regular pattern and/or an irregular pattern. In a regular pattern the discrete regions can be situated at regular intervals. In an irregular pattern the discrete regions can be situated at irregular intervals. The placement of the discrete regions can vary vertically and/or horizontally within a layer. Examples of discrete material regions embedded within a layer are shown in FIG. 3. Layer 304 includes regions have a different composition spanning the layer thickness. Layer 303 does not include discrete regions. Layer 302 include a discrete material region toward the upper half of the layer. Layers 302/303/304 overly layer 301 which can be a substrate or a layer of the multilayer article.

Discrete material regions can have, for example, a different density, a different cross-linking density, a different modulus, or a different filler content than the surrounding layer material. The embedded regions can serve, for example, to deflect and/or absorb acoustic waves caused by high-velocity impact of water droplets on the leading edge of a wind turbine blade.

The different compositions used to from a structured layer can impart properties to the layer that are different to those of a non-structured layer.

Coreactive additive manufacturing facilitates the ability to fabricate complex interface structures between layers.

Each layer of a multilayer article can have a substantially planar structure.

Alternatively, a layer interface can have a complex structure. A complex interface structure can improve the mechanical integrity of the multilayer structure.

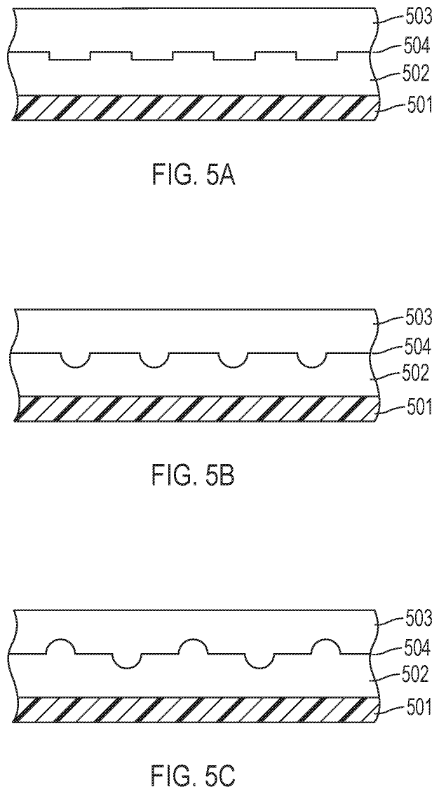

For example, the interface between adjoining layers can be configured to have an interdigitated structure as shown, for example, in FIG. 5A and/or an interlocking structure as shown in FIGS. 5B and 5C. Such complex layer interface can improve the integrity and long-term reliability of a layer interface. Referring to FIGS. 5A and 5B, layer 503 can be an exterior layer of a wind turbine blade or can be leading edge protection shield, and layer 502 can be an adhesive layer configured to bond exterior layer 503 to an underlying layer 501, which can comprise a substrate. Interface 504 can correspond to a surface of a layer fabricated using additive manufacturing such as three-dimensional printing and the topography can correspond to print lines. During assembly a leading edge protection shield corresponding to layer 503 can be applied onto uncured or partially cured adhesive layer 502. The topography created by the print lines can increase the integrity of the bonding interface between the leading edge protection shield or layer 503 and the adhesive layer 502.

Coreactive compositions of adjoining layers can be selected such that one or more compounds in the adjoining layers can coreact. For example, the coreactive compositions of adjoining layers can have the same curing chemistry. The coreactive compositions of adjoining layers can include compounds having functional groups that coreact with compounds in the adjoining layer. For example, a compound in a first layer can comprise reactive isocyanate groups capable of co-reacting with hydroxyl groups of a compound in a second, adjoining layer. Coreaction of adjoining layers improves the integrity and reliability of the interface between layers and eliminates or minimizes the need to apply an adhesion promoting layer. The adjoining surfaces of adjoining layers can be configured to have an excess of complimentary reactive functional groups to enhance the co-reactivity at the interface between adjoining layers.

Interlayer adhesion between adjoining layers of a multilayer coating can be enhanced in several ways.

For example, an adhesion-promoting coating can be applied between adjoining layers. An adhesion-promoting coating can include adhesion promoters and/or reactive groups capable of non-covalently bonding or covalently bonding to one or more components of each of the adjoining layers.

For multiple coextruded layers, interlayer adhesion can be enhanced by facilitating the ability of adjoining layers to covalently bond. This can be accomplished, for example, by including coreactive components in adjoining layers such that the coreactive components will covalently bond. For example, for layers based on thiol-ene chemistry, an adhesion-promoting interlayer coating can include compounds having unreacted groups capable of reacting with the thiol and/or the alkenyl groups of the overlying and underlying layers. For example, for layers based on amine-isocyanate (urea) chemistry, an adhesion-promoting interlayer coating can include compounds having unreacted groups capable of reacting with the amine and/or the isocyanate groups of the overlying and underlying layers.

An article provided by the present disclosure can comprise a plurality of adjoining side-by-side deposits of a coreactive composition, wherein the adjoining layers are chemically bonded, physically bonded, or both chemically and physically bonded.

An article provided by the present disclosure can be fabricated by extruding adjoining, side-by-side deposits of a coreactive composition to form a layer. The adjoining deposits comprising the coreactive composition can chemically bond and/or physical bond to create a mechanically strong interlayer interface. The strength of the inter-deposit interface between the adjoining deposits can be determined by measuring the fracture energy according to ASTM D7313. Adjoining deposits applied using coreactive additive manufacturing methods provided by the present disclosure can have a fracture energy that is substantially the same as the fracture energy of a similar layer formed from a single deposit. For example, the fracture energy of a sheet comprising adjacent deposits of a coreactive composition and the fracture energy of sheet of the coreactive composition formed from a single deposit can be, for example, within less than 10%, less than 5%, less than 2% or less 1%. This can be referred to as the relative fracture energy. The adjoining deposits can be applied using additive manufacturing such as three-dimensional printing, and the single deposit can be fabricated using methods such as roller coating or spreading. The layer formed from a single deposit of a coreactive composition does not have inter-deposit interfaces. The adjoining deposits or layers can be overlying layers, adjacent side-by-side layer, or partially overlying and partially adjacent side-by-side layers.

Coreactive layers can also be configured to facilitate adhesion to multiple substrates. For example, an adhesion package can be optimized for bonding a layer to a particular substrate. However, the adhesion package may not be optimal for facilitating bonding to a different substrate. For example, different adhesion packages can be optimized for bonding to different metals such as aluminum and titanium, or to composites and to metals. An adhesive package can be configured to bond to a fiber composite. An innermost layer of a multilayer article can include two or more portions having a different adhesion packages, and the other components of the coreactive composition can be substantially the same or different. In this way, bonding of the multilayer article to a substrate comprising different materials can be enhanced.

For adhesion to a substrate, the innermost layer of a multilayer article can comprise an adhesive layer. The adhesive layer can have a thickness, thickness profile, and malleability to ensure reliable adhesion to the surface of the substrate to which the multilayer coating is applied. It can be useful to structure the adhesive layer such that during application of the multilayer coating or an article such as a leading edge protection shield to a substrate the adhesive is progressively and evenly forced across the surface such as a damaged leading edge of a wind turbine blade to mitigate entrapment of voids and/or air bubbles which otherwise can compromise the long-term reliability of the adhesion.

Coreactive compositions include two or more mutually reactive compounds and one or more additives.

Coreactive compounds can be reactive at ambient conditions, i.e., 25° C., 1 atm, 50% RH. Coreactive compounds can be reactive, for example, at temperatures less than 50° C., less than 40° C., less than 30° C., or less than 25° C.

Coreactive compounds can include a prepolymer, an adduct, a monomer, or a combination of any of the foregoing.

Coreactive compounds can comprise mutually reactive functional groups. For example, a composition can comprise a first coreactive compound having one or more first functional groups and a second coreactive compound having one or more second functional groups, where the first functional group and the second functional group are coreactive.

The first and second functional groups can mutually react in the absence of a catalyst and/or in the presence of a catalyst. For example, the first and second functional groups can be reactive when combined under ambient conditions, such as at temperatures from 20° C. to 30° C. For example, the first and second functional groups can be reactive at a temperature less than 50° C., less than 40° C., less than 30° C., less than 25° C., or less than 20° C. The rate of the reaction can be modified in the presence of a catalyst. The rate of the reaction can be modified by temperature. The first and second functional groups may not be reactive under ambient conditions unless combined with a catalyst and/or until a catalyst is initiated. For example, the free-radical reactions between coreactive functional groups can take place upon initiation of a free-radical generator upon exposure to actinic radiation.

A coreactive composition used to form single and multilayer structures provided by the present disclosure can include a wide range of coreactive compounds and a wide range of curing chemistries. For example, a coreactive composition can comprise polyurethanes, polyureas, polyamines, polyaspartic amines, polyepoxides, polysiloxanes, fluorinated compounds, polythiols, polyols, or a combination of any of the foregoing.

A coreactive composition can comprise a combination of coreactants that impart desired properties to an article and/or layer. For example, a coreactive composition can comprise flexible compounds and rigid compounds, which can be selected in a ratio to achieve a desired combination of rigidity and flexibility. The ratio of the compounds can be designed to vary across the thickness and/or within the plane of a layer to impart a different level of rigidity/flexibility to different portions of the layer.

A coreactive compound can include a prepolymer or combination of prepolymers.

Prepolymers can influence, for example, the tensile strength, % elongation, hydrolytic stability, and chemical resistance of the cured polymer.

A prepolymer can have a number average molecular weight, for example, less than 20,000 Da, less than 10,000 Da, less than 8,000 Da, less than 6,000 Da, less than 4,000 Da, or less than 2,000 Da. A prepolymer can have a number average molecular weight, for example, greater than 2,000 Da, greater than 4,000 Da, greater than 6,000 Da, greater than 8,000 Da, greater than 10,000 Da, or greater than 15,000 Da. A prepolymer can have a number average molecular weight, for example, from 1,000 Da to 20,000 Da, from 2,000 Da to 10,000 Da, from 3,000 Da to 9,000 Da, from 4,000 Da to 8,000 Da, or from 5,000 Da to 7,000 Da.

Prepolymers can be liquid at 25° C. and can have a glass transition temperature Tg, for example, between −50° C. to 120° C., where the glass transition temperature Tg is determined by Dynamic Mass Analysis (DMA) using a TA Instruments Q800 apparatus with a frequency of 1 Hz, an amplitude of 20 microns, with the Tg identified as the peak of the tan δ curve.

Prepolymers can exhibit a viscosity, for example, within a range from 20 poise to 500 poise (2 Pa-sec to 50 Pa-sec), from 20 poise to 200 poise (2 Pa-sec to 20 Pa-sec) or from 40 poise to 120 poise (4 Pa-sec to 12 Pa-sec), measured using a Brookfield CAP 2000 viscometer, with a No. 6 spindle, at speed of 300 rpm, and a temperature of 25° C.

A prepolymer can have a reactive functionality, for example, less than 12, less than 10, less than 8, less than 6, or less than 4. Each of the first compound and the second compound can comprise a respective reactive functionality, for example, from 2 to 12, from 2 to 8, from 2 to 6, from 2 to 4, or from 2 to 3. Each of the first compound and the second compound can independently have a functionality, for example, of 2, 3, 4, 5, 6, 7, 8, 9, 10, 11, or 12. The number of reactive functionalities can determine the cross-linking density of the cured composition and thereby the material and layer properties.

A prepolymer can comprises any suitable backbone. A prepolymer backbone can be selected, for example, based on the end use requirements of a multilayer article and/or a particular layer. For example, a prepolymer backbone can be selected based considerations of tensile strength, %elongation, thermal resistance, chemical resistance, low temperature flexibility, hardness, and a combination of any of the foregoing. The selection of a prepolymer for use in a particular layer can also be based on cost considerations.

A prepolymer can include homopolymers and block copolymers. Prepolymers can include copolymers such as alternating copolymers, random copolymers, and/or block copolymers. For example, prepolymers can comprise segments that impart desired properties to a prepolymer backbone such as flexibility.

A prepolymer can comprise segments having different chemical structure and properties within the prepolymer backbone. The segments can be distributed randomly, in a regular distribution, or in blocks. The segments can be used to impart certain properties to the prepolymer backbone. For example, the segments can comprise flexible linkages such as thioether linkages into the polymer backbone. Segments having pendent groups can be incorporated into the prepolymer backbone to disrupt the symmetry of the prepolymer backbone. The segments can be introduced via the reactants used to prepare a sulfur-containing prepolymer and/or the lower molecular weight sulfur-containing prepolymers can be reacted with compounds containing the segments.

A backbone of a prepolymer can be selected depending on the desired mechanical and chemical properties of the respective layer and of the multilayer coating as a whole.

Example of suitable prepolymer backbones include polythioethers, polysulfides, monosulfides, polyformals, polyesters, polyurethanes, polyureas, phenol-formaldehyde resins, urea-formaldehyde resins, melamine resins, diallyl-phthalate, epoxy resins, epoxy novolac resins, benzoxazines, polyimides, bismaleimides, cyanate esters, furan resins, silicone resins, thiolytes, vinyl esters, polycarbonates, polyetherimides, phenolic resins, and combinations of any of the foregoing.

For example, a prepolymer backbone can comprise a polythioether, a polysulfide, a polyformal, a polyisocyanate, a polyurea, polycarbonate, polyphenylene sulfide, polyethylene oxide, polystyrene, acrylonitrile-butadiene-styrene, polycarbonate, styrene acrylonitrile, poly(methylmethacrylate), polyvinylchloride, polybutadiene, polybutylene terephthalate, poly(p-phenyleneoxide), polysulfone, polyethersulfone, polyethylenimine, polyphenylsulfone, acrylonitrile styrene acrylate, polyethylene, syndiotactic or isotactic polypropylene, polylactic acid, polyamide, ethyl-vinyl acetate homopolymer or copolymer, polyurethane, copolymers of ethylene, copolymers of propylene, impact copolymers of propylene, polyetheretherketone, polyoxymethylene, syndiotactic polystyrene (SPS), polyphenylene sulfide (PPS), liquid crystalline polymer (LCP), homo- and copolymer of butene, homo- and copolymers of hexene; and combinations of any of the foregoing.

Examples of other suitable prepolymer backbones include polyolefins (such as polyethylene, linear low density polyethylene (LLDPE), low density polyethylene (LDPE), high density polyethylene, polypropylene, and olefin copolymers), styrene/butadiene rubbers (SBR), styrene/ethylene/butadiene/styrene copolymers (SEBS), butyl rubbers, ethylene/propylene copolymers (EPR), ethylene/propylene/diene monomer copolymers (EPDM), polystyrene (including high impact polystyrene), poly(vinyl acetates), ethylene/vinyl acetate copolymers (EVA), poly(vinyl alcohols), ethylene/vinyl alcohol copolymers (EVOH), poly(vinyl butyral), poly(methyl methacrylate) and other acrylate polymers and copolymers (including such as methyl methacrylate polymers, methacrylate copolymers, polymers derived from one or more acrylates, methacrylates, ethyl acrylates, ethyl methacrylates, butyl acrylates, butyl methacrylates and the like), olefin and styrene copolymers, acrylonitrile/butadiene/styrene (ABS), styrene/acrylonitrile polymers (SAN), styrene/maleic anhydride copolymers, isobutylene/maleic anhydride copolymers, ethylene/acrylic acid copolymers, poly(acrylonitrile), polycarbonates (PC), polyamides, polyesters, liquid crystalline polymers (LCPs), poly(lactic acid), poly(phenylene oxide) (PPO), PPO-polyamide alloys, polysulfone (PSU), polyetherketone (PEK), polyetheretherketone (PEEK), polyimides, polyoxymethylene (POM) homo- and copolymers, polyetherimides, fluorinated ethylene propylene polymers (FEP), poly(vinyl fluoride), poly(vinylidene fluoride), poly(vinylidene chloride), and poly(vinyl chloride), polyurethanes (thermoplastic and thermosetting), aramides (such as Kevlar® and Nomex®), polytetrafluoroethylene (PTFE), polysiloxanes (including polydimethylenesiloxane, dimethylsiloxane/vinylmethylsiloxane copolymers, vinyldimethylsiloxane terminated poly(dimethylsiloxane)), elastomers, epoxy polymers, polyureas, alkyds, cellulosic polymers (such as ethyl cellulose, ethyl hydroxyethyl cellulose, carboxymethyl cellulose, cellulose acetate, cellulose acetate propionates, and cellulose acetate butyrates), polyethers and glycols such as poly(ethylene oxide)s (also known as poly(ethylene glycol)s, poly(propylene oxide)s (also known as poly(propylene glycol)s, and ethylene oxide/propylene oxide copolymers, acrylic latex polymers, polyester acrylate oligomers and polymers, polyester diol diacrylate polymers, and UV-curable resins.

Prepolymers having an elastomeric backbone can also be used. Examples of suitable prepolymers having n elastomeric backbone include polyethers, polybutadienes, fluoroelastomers, perfluoroelastomers, ethylene/acrylic copolymers, ethylene propylene diene terpolymers, nitriles, polythiolamines, polysiloxanes, polytetramethyleneglycols (PTMEG), polypropylene glycols, polyoxypropylene glycols, and combinations of any of the foregoing.

A prepolymer can comprise a polyether backbone. A polyether backbone can comprise at least one alkylene oxide, such as an ethylene oxide and/or propylene oxide. Examples of suitable polyether backbones include poly(oxytetramethylene)s, poly(oxytetraethylene)s, poly(oxy-1,2-propylene)s, and poly(oxy-1,2-butylene)s, and combinations of any of the foregoing.

These and other prepolymers can be combined with a suitable curing chemistry to provide useful coreactive compositions.

A multilayer article can be required to exhibit chemical resistance. The chemical resistance can be with respect to, for example, cleaning solvents, fuels, hydraulic fluids, lubricants, oils, pollutants, acid rain, corrosive chemicals corrosive particulates, and/or salt spray.

In these applications it can be desirable that one or more layers of a multilayer article exhibit chemical resistance. Chemical resistance refers to the ability of a multilayer article to maintain acceptable physical and mechanical properties following exposure to atmospheric conditions such as moisture and temperature and following exposure to chemicals such as cleaning solvents, fuels, hydraulic fluid, lubricants, oils, pollutants, acid rain, corrosive chemicals corrosive particulates, and/or salt spray. For example, one layer can exhibit chemical resistance, or two or more layers can exhibit chemical resistance to various degrees.

Examples of chemically-resistant prepolymers include sulfur-containing prepolymers. A chemically-resistant lead edge layer or leading edge protection shield of a wind turbine blade can comprise a sulfur-containing polymer.

Compounds, including sulfur-containing prepolymers, having a high sulfur content can be useful in imparting chemical resistance to a coreactive composition. For example, a sulfur-containing prepolymer can have a sulfur content greater than 10 wt %, greater than 12 wt %, greater than 15 wt %, greater than 18 wt %, greater than 20 wt %, or greater than 25 wt %, where wt % is based on the total weight of the prepolymer. A chemically resistant prepolymer can have a sulfur content, for example, from 10 wt % to 25 wt %, from 12 wt % to 23 wt %, from 13 wt % to 20 wt %, or from 14 wt % to 18 wt %, where wt % is based on the total weight of the prepolymer.

Examples of sulfur-containing prepolymers include polythioether prepolymers, polysulfide prepolymers, sulfur-containing polyformal prepolymers, monosulfide prepolymers, and combinations of any of the foregoing.

Coreactive compositions can comprise a monomer, a combination of monomers, an oligomer, a combination of oligomers, or a combination of any of the foregoing. An oligomer refers to a low molecular compound having repeat units. For example, certain resins used as curing agents are mixtures comprising low molecular weight oligomers formed by reacting monomers. An oligomer can be prepared by coreacting different monomers.

A monomer and/or oligomer can have a molecular weight, for example, less than 1,000 Da, less than 800 Da less than 600 Da, less than 500 Da, less than 400 Da, or less than 300 Da. A monomer and/or oligomer can have a molecular weight, for example, from 100 Da to 1,000 Da, from 100 Da to 800 Da, from 100 Da to 600 Da, from 150 Da, to 550 Da, or from 200 Da to 500 Da. A monomer and/or oligomer can have a molecular weight greater than 100 Da, greater than 200 Da, greater than 300 Da, greater than 400 Da, greater than 500 Da, greater than 600 Da, or greater than 800 Da.

A monomer and/or an oligomer can have a reactive functionality of two or more, for example, from 2 to 6, from 2 to 5, or from 2 to 4. A monomer and/or an oligomer can have a functionality of 2, 3, 4, 5, 6, or a combination of any of the foregoing. A monomer and/or oligomer can have an average reactive functionality, for example, from 2 to 6, from 2 to 5, from 2 to 4, from 2 to 3, from 2.1 to 2.8, or from 2.2 to 2.6.

A monomer and/or an oligomer can comprise any suitable functional group such as, for example, thiol, alkenyl, alkynyl, epoxy, isocyanate, Michael acceptor, hydroxyl, amine, Michael donor group or other suitable reactive group.

A monomer and/or oligomer can comprise a sulfur-containing monomer and/or a sulfur-containing oligomer.

A monomer and/or an oligomer can have a sulfur content, for example, from 0 wt % to 80 wt %, from 2 wt % to 75 wt %, from 5 wt % to 70 wt %, from 10 wt % to 65 wt %, from 15 wt % to 60 wt %, or from 20 wt % to 50 wt %, where wt % is based on the total molecular weight of the monomer and/or oligomer. A monomer and/or an oligomer can have a sulfur content, for example, greater than 0 wt %, greater than 10 wt %, greater than greater than 20 wt %, greater than 30 wt %, greater than 40 wt %, greater than 50 wt %, greater than 60 wt %, greater than 70 wt % or greater than 80 wt %, where wt % is based on the total molecular weight of the monomer and/or oligomer. A monomer and/or an oligomer can have a sulfur content, for example, less than 80 wt %, less than 70 wt %, less than 60 wt %, less than 50 wt %, less than 40 wt %, less than 30 wt %, less than 20 wt %, less than 10 wt %, or less than 5 wt %, where wt % is based on the total molecular weight of the monomer and/or oligomer.

In a coreactive composition, all monomers and oligomers can contain sulfur no, no monomers and oligomers can contain sulfur atoms, or some monomers and oligomers can contain sulfur atoms.

The combination of prepolymers, monomers, and oligomers in a coreactive composition can be selected such that the sulfur content of the coreactive composition can be, for example, greater than 10 wt %, greater than 12 wt %, greater than 15 wt %, greater than 18 wt %, greater than 20 wt %, or greater than 25 wt %, where wt % is based on the total weight of the prepolymers, monomers, and oligomers forming a composition.

A monomer or oligomer can comprise, for example, a polythiol, a polyalkenyl, a polyalkynyl, a polyepoxide, a polyfunctional Michael acceptor, a polyisocyanate, a polyol, a polyamine, or a combination of any of the foregoing.

A coreactive composition can comprise an adduct or combination of adducts. Adducts refer to compounds that can be prepared by reacting monomers. Adducts have can have a molecular weight that is less than that of a prepolymer and from about 2 to 6 times greater than that of a prepolymer. Adducts can be used to provide polymerization precursors having a different reactive functionality that that of a parent monomer.

A coreactive composition can comprise a polyfunctionalizing agent or a combination of polyfunctionalizing agents.

Polyfunctionalizing agents can be monomers having a functionality of 3 or more that can be included in a composition to increase the cross-linking density of a cured coreactive composition.

A polyfunctionalizing agent can comprise an average functionality, for example, from 3 to 6, such as from 3 to 5, or from 3 to 4. A polyfunctionalizing agent can have a functionality of 3, 4, 5, 6, or a combination of any of the foregoing.

A polyfunctionalizing agent can comprise, for example, a polythiol, a polyalkenyl, a polyalkynyl, a polyepoxide, a polyfunctional Michael acceptor, a polyisocyanate, a polyol, or a combination of any of the foregoing.

The content of extruded coreactive compositions can be continuously or intermittently varied during the extrusion process. In this way the material properties of the coreactive composition can be selected and controlled. For example, the amount of a coreactant or a cross-linking agent can be changed to create layers having different regions with a different elastic modulus or other physical property.

A coreactive composition can comprise a first compound having one or more first functional groups and a second compound having one or more second functional groups, where the one or more first functional groups and the one or more second functional groups are coreactive. The one or more functional groups refers to the number of functional groups and/or the type of functional group.

For example, the one or more functional groups can be from 1 to 12 functional groups, from 2 to 10, from 2 to 6, from 2 to for or from 2 to 3. For example, a compound can comprise 1, 2, 3, 4, 5, 6, 7, 8, 9, or 10 functional groups. A compound can have greater than 1 functional group, greater than 2 functional groups, or greater than 3 functional groups. A composition can have one or more compounds having one or more first functional groups.

The one or more functional groups can refer to different type of reactive functional groups. For example, if the first functional group is a thiol group, the second functional group can be a thiol group, an isocyanate group, an epoxy group, a Michael acceptor group, an alkenyl group, or a combination of any of the foregoing.

Any suitable curing chemistry can be used.

Examples of suitable curing chemistries include thiol/thiol, thiol/isocyanate, thiol/Michael acceptor, thiol/epoxy, hydroxyl/isocyanate, amine/isocyanate, epoxy/epoxy, and Michael acceptor/Michael acceptor reactions.

Thus, a first functional group can comprise an isocyanate and a second functional group can comprise a hydroxyl group, an amine group, or a combination thereof.

A first functional group can comprise a thiol group and a second functional group can comprise a thiol group, an isocyanate group, a Michael acceptor group, an epoxy group, or a combination of any of the foregoing.

A first functional group can comprise an epoxy group and a second functional group can comprise an epoxy group.

A first functional group can comprise a Michael acceptor group and a second functional group can comprise a Michael acceptor group.

A first functional group can be a saturated functional group and the second functional group can be an unsaturated group. Each of the first functional group and the second functional can comprise a saturated functional group. Each of the first functional group and the second functional can comprise an unsaturated functional group. A saturated functional group refers to a functional group having a single bond. Examples of saturated functional groups include thiol, hydroxyl, primary amine, secondary amine, and epoxy groups. An unsaturated functional group refers to a group having a reactive double bond. Examples of unsaturated functional groups include alkenyl groups, Michael acceptor groups, isocyanate groups, acyclic carbonate groups, acetoacetate groups, carboxylic acid groups, vinyl ether groups, (meth)acrylate groups, and malonate groups.

The first functional group can be a carboxylic acid group and the second functional group can be an epoxy group.

The first functional group can be a Michael acceptor group such as a (meth)acrylate group, a maleic group, or a fumaric group, and the second functional group can be a primary amine group or a secondary amine group.

The first functional group can be an isocyanate group and the second functional group can be a primary amine group, a secondary amine group, a hydroxyl group, or a thiol group.

The first functional group can be a cyclic carbonate group, an acetoacetate group, or an epoxy group; and the second functional group can be a primary amine group, or a secondary amine group.

The first functional group can be a thiol group, and the second functional group can be an alkenyl group, a vinyl ether group, a (meth)acrylate group.

The first functional group can be a Michael acceptor group such as (meth)acrylate group, a cyanoacrylate, a vinylether a vinylpyridine, or an α,β-unsaturated carbonyl group and the second functional group can be a malonate group, an acetylacetonate, a nitroalkane, or other active alkenyl group.

The first functional group can be a thiol group, and the second functional group can be an alkenyl group, an epoxy group, an isocyanate group, an alkynyl group, or a Michael acceptor group.

The first functional group can be a Michael donor group, and the second functional group can be a Michael acceptor group.

Both the first functional group and the second functional group can be thiol groups.

Both the first functional group and the second functional group can be alkenyl groups.

Both the first functional group and the second functional group can be Michael acceptor groups such as (meth)acrylate groups.

The cure rate for any of these chemistries can be modified by including an appropriate catalyst.

To form a multilayer coating, it can be desirable that certain layers cure faster than other layers. For example, it can be desirable that an exterior layer cure fast to facilitate the ability of an applied multilayer article to retain an intended shape, and an interior layer to cure slowly to develop adhesion and/or desirable physical properties.

A coreactive composition can have a tack free time, for example, is greater than 2 min, greater than 5 min, greater than 10 min, greater than 20 min, greater than 40 min, greater than 60 min, greater than 120 min, greater than 240 min, or greater than 480 min, as determined using the cotton ball test method. A coreactive composition can have a tack free time, for example, from 2 min to 500 min, from 10 min to 400 min, from 30 min to 300 min, or from 60 min to 200 min, as determined using the cotton ball test method. A coreactive composition can have a tack free time, for example, less than 500 min, less than 400 min, less than 300 min, less than 200 min, less than 100 min, or less than 50 min, as determined using the cotton ball test method.

A coreactive composition can have a viscosity, for example, less than 200,000 poise, less than 100,000 poise, less than 50,000 poise, less than 25,000 poise, or less than 10,000 poise, measured using a Brookfield CAP 2000 viscometer, with a No. 6 spindle, at speed of 300 rpm, and a temperature of 25° C. A coreactive composition can have a viscosity, for example, greater than 1,000 poise, greater than 5,000 poise, greater than 10,000 poise, greater than 25,000 poise, greater than 50,000 poise, greater than 100,000 poise measured using a Brookfield CAP 2000 viscometer, with a No. 6 spindle, at speed of 300 rpm, and a temperature of 25° C. A coreactive composition can have a viscosity, for example, from 1,000 poise to 200,000 poise, from 5,000 poise to 100,000 poise, or from 10,000 poise to 50,000 poise measured using a Brookfield CAP 2000 viscometer, with a No. 6 spindle, at speed of 300 rpm, and a temperature of 25° C.

A coreactive composition can include one or more additives. The one or more additives can comprise, for example, catalysts, polymerization initiators, adhesion promoters, reactive diluents, plasticizers, filler, colorants, photochromic agents, rheology modifiers, cure activators and accelerators, corrosion inhibitors, fire retardants, UV stabilizers, rain erosion inhibitors, and combinations of any of the foregoing.

An additive can be dispersed homogenously or in-homogeneously within a layer and the concentration of an additive can be homogenous or inhomogeneous within a layer.

A coreactive composition can include a catalyst or a combination of catalysts.

A catalyst can be selected to accelerate the reaction of the coreactants. The concentration of a catalyst can be selected to control the cure rate of the coreactants.

A catalyst or combination of catalysts can be selected to catalyze the reaction of coreactants in the coreactive composition such as the reaction of the first compound and the second. The appropriate catalyst will depend on the curing chemistry. For example, a thiol-ene or thiol epoxy can comprise an amine catalyst.

A coreactive composition can comprise from 0.1 wt % to 1 wt %, from 0.2 wt % to 0.9 wt %, from 0.3 wt % to 0.7 wt %, or from 0.4 wt % to 0.6 wt % of an amine catalyst or combination of amine catalysts, where wt % is based on the total weight of the coreactive composition.

A catalyst can include a latent catalyst or combination of latent catalysts. Latent catalysts include catalysts that have little or no activity until released or activated, for example, by physical and/or chemical mechanisms. Latent catalysts may be contained within a structure or may be chemically blocked. A controlled release catalyst may release a catalyst upon exposure to ultraviolet radiation, heat, ultrasonication, or moisture. A latent catalyst can be sequestered within a core-shell structure or trapped within a matrix of a crystalline or semi-crystalline polymer where the catalyst can diffuse from the encapsulant with time or upon activation such as by the application of thermal or mechanical energy.

A coreactive composition can comprise a dark cure catalyst or a combination of dark cure catalysts. A dark cure catalyst refers to a catalyst capable of generating free radicals without being exposed to electromagnetic energy. Dark cure catalysts include, for example, combinations of metal complexes and organic peroxides, tialkylborane complexes, borane/amine complexes, and peroxide-amine redox initiators. A dark cure catalyst can be used in conjunction with a photopolymerization initiator or independent of a photopolymerization initiator.

A coreactive composition can comprise one or more catalysts.

A cure retarder can be selected to accelerate the reaction of the coreactants.

A coreactive composition can comprise one or more free radial initiators such as thermally activated free radical initiators or free radical imitators activated by actinic radiation.

A coreactive composition can be curable by actinic radiation such as a coreactive composition based on thiol/ene and ene/ene curing chemistries. A coreactive composition that is curable by visible or ultraviolet radiation can comprise a photopolymerization initiator or combination of photopolymerization initiators.

A coreactive composition can include a photoinitiator or combination of photoinitiators. The radiation can be actinic radiation that can apply energy effective in generating an initiating species from a photopolymerization initiator upon irradiation therewith, and widely includes α-rays, γ-rays, X-rays, ultraviolet (UV) light including UVA, UVA, and UVC spectra), visible light, blue light, infrared, near-infrared, or an electron beam. For example, a photoinitiator can be a UV photoinitiator.

Examples of suitable UV photoinitiators include a-hydroxyketones, benzophenone, α,α-diethoxyacetophenone, 4,4-diethylaminobenzophenone, 2,2-dimethoxy-2-phenylacetophenone, 4-isopropylphenyl 2-hydroxy-2-propyl ketone, 1-hydroxycyclohexyl phenyl ketone, isoamyl p-dimethylaminobenzoate, methyl 4-dimethylaminobenzoate, methyl O-benzoylbenzoate, benzoin, benzoin ethyl ether, benzoin isopropyl ether, benzoin isobutyl ether, 2-hydroxy-2-methyl-1-phenylpropan-1-one, 2-isopropylthioxanthone, dibenzosuberone, 2,4,6-trimethylbenzoyldiphenylphosphine oxide, biscyclophosphine oxide, benzophenone photoinitiators, oxime photoinitiators, phosphine oxide photoinitiators, and combinations of any of the foregoing.

A coreactive composition can comprise from 0.05 wt % to 5 wt %, from 0.1 wt % to 4.0 wt %, from 0.25 wt % to 3.0 wt %, from 0.5 wt % to 1.5 wt % of a photoinitiator or combination of photoinitiators, where wt % is based on the total weight of the polymerizable composition.

A coreactive composition can comprise a thermally active free radical initiator. A thermally activated free radical initiator can become active at elevated temperature, such as at a temperature greater than 25° C.

Examples of suitable thermally activated free radical initiators include organic peroxy compounds, azobis(organonitrile) compounds, N-acyloxyamine compounds, O-imino-isourea compounds, and combinations of any of the foregoing. Examples of suitable organic peroxy compounds, that may be used as thermal polymerization initiators include peroxymonocarbonate esters, such as tertiarybutylperoxy 2-ethylhexyl carbonate and tertiarybutylperoxy isopropyl carbonate; peroxyketals, such as 1,1-di-(tent-butyl peroxy)-3,3,5-trimethylcyclohexane; peroxydicarbonate esters, such as di(2-ethylhexyl)peroxydicarbonate, di(secondary butyl)peroxydicarbonate and diisopropylperoxydicarbonate; diacyperoxides such as 2,4-dichlorobenzoyl peroxide, isobutyryl peroxide, decanoyl peroxide, lauryl peroxide, propionyl peroxide, acetyl peroxide, benzoyl peroxide, and p-chlorobenzoyl peroxide; peroxyesters such as tert-butylperoxy pivalate, tert-butylperoxy octylate, and tert-butylperoxyisobutyrate; methylethylketone peroxide, acetylcyclohexane sulfonyl peroxide, and combinations of any of the foregoing. Other examples of suitable peroxy compounds include 2,5-dimethyl-2,5-di(2-ethylhexanoylperoxy)hexane, and/or 1,1-bis(tert-butylperoxy)-3,3,5-trimethylcyclohexane. Examples of suitable azobis(organonitrile) compounds that may be used as thermal polymerization initiators include azobis(isobutyronitrile), 2,2′-azobis(2-methyl-butanenitrile), and/or azobis(2/1-dimethylvaleronitrile). A thermally activated free radical initiator can comprise 1-acetoxy-2,2,6,6-tetramethylpiperidine and/or 1,3-dicyclohexyl-O—(N-cyclohexylideneamino)-isourea.

A coreactive composition for forming a multilayer coating can comprise a filler or combination of filler. A filler can comprise, for example, inorganic filler, organic filler, low-density filler, conductive filler, or a combination of any of the foregoing.

A coreactive composition for forming a multilayer coating can comprise an inorganic filler or combination of inorganic filler.

An inorganic filler can be included to provide mechanical reinforcement and to control the rheological properties of the composition. Inorganic filler may be added to compositions to impart desirable physical properties such as, for example, to increase the impact strength, to control the viscosity, or to modify the electrical properties of a cured composition.

Inorganic filler useful in coreactive compositions include carbon black, calcium carbonate, precipitated calcium carbonate, calcium hydroxide, hydrated alumina (aluminum hydroxide), talc, mica, titanium dioxide, alumina silicate, carbonates, chalk, silicates, glass, metal oxides, graphite, and combinations of any of the foregoing.

Suitable calcium carbonate filler includes products such as Socal® 31, Socal® 312, Socal® U1S1, Socal® UaS2, Socal® N2R, Winnofil® SPM, and Winnofil® SPT available from Solvay Special Chemicals. A calcium carbonate filler can include a combination of precipitated calcium carbonates.

Inorganic filler can be surface treated to provide hydrophobic or hydrophilic surfaces that can facilitate dispersion and compatibility of the inorganic filler with other components of a coreactive composition. An inorganic filler can include surface-modified particles such as, for example, surface modified silica. The surface of silica particles can be modified, for example, to be tailor the hydrophobicity or hydrophilicity of the surface of the silica particle. The surface modification can affect the dispensability of the particles, the viscosity, the curing rate, and/or the adhesion.

A coreactive composition can comprise an organic filler or a combination of organic filler.

Organic filler can be selected to have a low specific gravity and to be resistant to solvents such as JRF Type I and/or to reduce the density of a coating layer. Suitable organic filler can also have acceptable adhesion to the sulfur-containing polymer matrix. An organic filler can include solid powders or particles, hollow powders or particles, or a combination thereof.

An organic filler can have a specific gravity, for example, less than 1.15, less than 1.1, less than 1.05, less than 1, less than 0.95, less than 0.9, less than 0.8, or less than 0.7. Organic filler can have a specific gravity, for example, within a range from 0.85 to 1.15, within a range from 0.9 to 1.1, within a range from 0.9 to 1.05, or from 0.85 to 1.05.

Organic filler can comprise thermoplastics, thermosets, or a combination thereof. Examples of suitable thermoplastics and thermosets include epoxies, epoxy-amides, ETFE copolymers, nylons, polyethylenes, polypropylenes, polyethylene oxides, polypropylene oxides, polyvinylidene chlorides, polyvinylfluorides, TFE, polyamides, polyimides, ethylene propylenes, perfluorohydrocarbons, fluoroethylenes, polycarbonates, polyetheretherketones, polyetherketones, polyphenylene oxides, polyphenylene sulfides, polystyrenes, polyvinyl chlorides, melamines, polyesters, phenolics, epichlorohydrins, fluorinated hydrocarbons, polycyclics, polybutadienes, polychloroprenes, polyisoprenes, polysulfides, polyurethanes, isobutylene isoprenes, silicones, styrene butadienes, liquid crystal polymers, and combinations of any of the foregoing.

Examples of suitable polyamide 6 and polyamide 12 particles are available from Toray Plastics as grades SP-500, SP-10, TR-1, and TR-2. Suitable polyamide powders are also available from the Arkema Group under the tradename Orgasol®, and from Evonik Industries under the tradename Vestosin®.

An organic filler can have any suitable shape. For example, an organic filler can comprise fractions of crushed polymer that has been filtered to select a desired size range. An organic filler can comprise substantially spherical particles. Particles can be solid or can be porous.

An organic filler can have an average particle size, for example, within a range from 1 μm to 100 μm, 2 μm to 40 μm, from 2 μm to 30 μm, from 4 μm to 25 μm, from 4 μm to 20 μm, from 2 μm to 12 μm, or from 5 μm to 15 μm. An organic filler can have an average particle size, for example, less than 100 μm, less than 75 μm, less than 50 μm, less than 40 μm, or less than 20 μm. Particle size distribution can be determined using a Fischer Sub-Sieve Sizer or by optical inspection.

An organic filler can include a low density such as a modified, expanded thermoplastic microcapsules. Suitable modified expanded thermoplastic microcapsules can include an exterior coating of a melamine or urea/formaldehyde resin.

A coreactive composition can comprise low density microcapsules. A low-density microcapsule can comprise a thermally expandable microcapsule.

A thermally expandable microcapsule refers to a hollow shell comprising a volatile material that expands at a predetermined temperature. Thermally expandable thermoplastic microcapsules can have an average initial particle size of 5 μm to 70 μm, in some cases 10 μm to 24 μm, or from 10 μm to 17 μm. The term “average initial particle size” refers to the average particle size (numerical weighted average of the particle size distribution) of the microcapsules prior to any expansion. The particle size distribution can be determined using a Fischer Sub-Sieve Sizer or by optical inspection.

Examples of materials suitable for forming the wall of a thermally expandable microcapsule include polymers of vinylidene chloride, acrylonitrile, styrene, polycarbonate, methyl methacrylate, ethyl acrylate, and vinyl acetate, copolymers of these monomers, and combinations of the polymers and copolymers. A crosslinking agent may be included with the materials forming the wall of a thermally expandable microcapsule.

Examples of suitable thermoplastic microcapsules include Expancel® microcapsules such as Expancel® DE microspheres available from AkzoNobel. Examples of suitable Expancel™ DE microspheres include Expancel® 920 DE 40 and Expancel® 920 DE 80. Suitable low-density microcapsules are also available from Kureha Corporation.

Low density filler such as low density microcapsules can be characterized by a specific gravity within a range from 0.01 to 0.09, from 0.04 to 0.09, within a range from 0.04 to 0.08, within a range from 0.01 to 0.07, within a range from 0.02 to 0.06, within a range from 0.03 to 0.05, within a range from 0.05 to 0.09, from 0.06 to 0.09, or within a range from 0.07 to 0.09, wherein the specific gravity is determined according to ASTM D1475. Low density filler such as low-density microcapsules can be characterized by a specific gravity less than 0.1, less than 0.09, less than 0.08, less than 0.07, less than 0.06, less than 0.05, less than 0.04, less than 0.03, or less than 0.02, wherein the specific gravity is determined according to ASTM D1475.

Low density filler such as low microcapsules can be characterized by a mean particle diameter from 1 μm to 100 μm and can have a substantially spherical shape. Low density filler such as low-density microcapsules can be characterized, for example, by a mean particle diameter from 10 μm to 100 μm, from 10 μm to 60 μm, from 10 μm to 40 μm, or from 10 μm to 30 μm, as determined according to ASTM D1475.

Low density filler such as low-density microcapsules can comprise expanded microcapsules or microballoons having a coating of an aminoplast resin such as a melamine resin. Aminoplast resin-coated particles are described, for example, in U.S. Pat. No. 8,993,691. Such microcapsules can be formed by heating a microcapsule comprising a blowing agent surrounded by a thermoplastic shell. Uncoated low-density microcapsules can be reacted with an aminoplast resin such as a urea/formaldehyde resin to provide a coating of a thermoset resin on the outer surface of the particle.

With the coating of an aminoplast resin, an aminoplast-coated microcapsule can be characterized by a specific gravity, for example, within a range from 0.02 to 0.08, within a range from 0.02 to 0.07, within a range from 0.02 to 0.06, within a range from 0.03 to 0.07, within a range from 0.03 to 0.065, within a range from 0.04 to 0.065, within a range from 0.045 to 0.06, or within a range from 0.05 to 0.06, wherein the specific gravity is determined according to ASTM D1475.

A coreactive composition can comprise micronized oxidized polyethylene homopolymer. An organic filler can include a polyethylenes, such as an oxidized polyethylene powder. Suitable polyethylenes are available, for example, from Honeywell International, Inc. under the tradename ACumist®, from INEOS under the tradename Eltrex®, and Mitsui Chemicals America, Inc. under the tradename Mipelon®.

A coreactive composition can comprise, for example, from 1 wt % to 90 wt % of low-density filler, from 1 wt % to 60 wt %, from 1 wt % to 40 wt %, from 1 wt % to 20 wt %, from 1 wt % to 10 wt %, or from 1 wt % to 5 wt % of low-density filler, where wt % is based on the total weight of the coreactive composition.

A coreactive composition can comprise greater than 1 wt % low density filler, greater than 1 wt %, greater than 2 wt %, greater than 3 wt %, greater than 4 wt %, greater than 1 wt %, or greater than 10 wt % low-density filler, where wt % is based on the total weight of the coreactive composition.

A coreactive composition can comprise from 1 vol % to 90 vol % low-density filler, from 5 vol % to 70 vol %, from 10 vol % to 60 vol %, from 20 vol % to 50 vol %, or from 30 vol % to 40 vol % low density filler, where vol % is based on the total volume of the coreactive composition.

A coreactive composition can comprise greater than 1 vol % low-density filler, greater than 5 vol %, greater than 10 vol %, greater than 20 vol %, greater than 30 vol %, greater than 40 vol %, greater than 50 vol %, greater than 60 vol %, greater than 70 vol %, or greater than 80 vol % low-density filler, where vol % is based on the total volume of the coreactive composition.

A coreactive composition can include a conductive filler or a combination of conductive filler. A conductive filler can include electrically conductive filler, semiconductive filler, thermally conductive filler, magnetic filler, EMI/RFI shielding filler, static dissipative filler, electroactive filler, or a combination of any of the foregoing.

A coreactive composition can comprise an electrically conductive filler or combination of electrically conductive filler.

To render a part electrically conductive, the concentration of an electrically conductive filler can be above the electrical percolation threshold, where a conductive network of electrically conductive particles is formed. Once the electrical percolation threshold is achieved, the increase in conductivity as function of filler loading can be modeled by a simple power-law expression:

σ_{c}=σ_{f}(φ−φ_{c})ₜ EQN. 1

where φ is the filler volume fraction, φ_{c} is the percolation threshold, σ_{f} is the filler conductivity, φ is the composite conductivity, and t is a scaling component. The filler need not be in direct contact for current flow and conduction can take place via tunneling between thin layers of binder surrounding the electrically conductive filler particles, and this tunneling resistance can be the limiting factor in the conductivity of an electrically conductive composite.

A conductive filler can have any suitable shape and/or dimensions. For example, an electrically conductive filler can be in form of particles, powders, flakes, platelets, filaments, fiber, crystals, or a combination of any of the foregoing.

A conductive filler can comprise a combination of conductive filler having different shapes, different dimensions, different properties such as, for example, different thermal conduction, electrical conduction, magnetic permittivity, electromagnetic properties, or a combination of any of the foregoing.

A conductive filler can be a solid or can be in the form of a substrate such as a particle having a coating of a conductive material. For example, a conductive filler can be a low-density microcapsule having an exterior conductive coating.

Examples of suitable conductive filler such as electrically conductive filler include metals, metal alloys, conductive oxides, semiconductors, carbon, carbon fiber, and combinations of any of the foregoing.

Other examples of electrically conductive filler include electrically conductive noble metal-based filler such as pure silver; noble metal-plated noble metals such as silver-plated gold; noble metal-plated non-noble metals such as silver plated cooper, nickel or aluminum, for example, silver-plated aluminum core particles or platinum-plated copper particles; noble-metal plated glass, plastic or ceramics such as silver-plated glass microspheres, noble-metal plated aluminum or noble-metal plated plastic microspheres; noble-metal plated mica; and other such noble-metal conductive filler. Non-noble metal-based materials can also be used and include, for example, non-noble metal-plated non-noble metals such as copper-coated iron particles or nickel-plated copper; non-noble metals, e.g., copper, aluminum, nickel, cobalt; non-noble-metal-plated-non-metals, e.g., nickel-plated graphite and non-metal materials such as carbon black and graphite. Combinations of electrically conductive filler and shapes of electrically conductive filler can be used to achieve a desired conductivity, EMI/RFI shielding effectiveness, hardness, and other properties suitable for a particular application.

Organic filler, inorganic filler, and low-density filler can be coated with a metal to provide conductive filler.

An electrically conductive filler can include graphene. Graphene comprises a densely packed honeycomb crystal lattice made of carbon atoms having a thickness equal to the atomic size of one carbon atom, i.e., a monolayer of sp² hybridized carbon atoms arranged in a two-dimensional lattice.

Graphene can comprise graphenic carbon particles. Graphenic carbon particles refer to carbon particles having structures comprising one or more layers of one-atom-thick planar sheets of sp²-bonded carbon atoms that are densely packed in a honeycomb crystal lattice. An average number of stacked layers can be less than 100, for example, less than 50. An average number of stacked layers can be 30 or less, such as 20 or less, 10 or less, or, in some cases, 5 or less. Graphenic carbon particles can be substantially flat, however, at least a portion of the planar sheets may be substantially curved, curled, creased or buckled. Graphenic carbon particles typically do not have a spheroidal or equiaxed morphology.

Graphenic carbon particles can have a thickness, measured in a direction perpendicular to the carbon atom layers, for example, of no more than 10 nm, no more than 5 nm, or no more than 4 or 3 or 2 or 1 nm, such as no more than 3.6 nm. Graphenic carbon particles can be from 1 atom layer up to 3, 6, 9, 12, 20 or 30 atom layers thick, or more. Graphenic carbon particles can have a width and length, measured in a direction parallel to the carbon atoms layers, of at least 50 nm, such as more than 100 nm, more than 100 nm up to 500 nm, or more than 100 nm up to 200 nm. Graphenic carbon particles can be provided in the form of ultrathin flakes, platelets or sheets having relatively high aspect ratios, where the aspect ratio is the ratio of the longest dimension of a particle to the shortest dimension of the particle, of greater than 3:1, such as greater than 10:1.

Graphenic carbon particles can comprise exfoliated graphite and have different characteristics in comparison with the thermally produced graphenic carbon particles, such as different size distributions, thicknesses, aspect ratios, structural morphologies, oxygen contents, and chemical functionalities at the basal planes/edges.

Graphenic carbon particles can be functionalized. Functionalized graphenic carbon particles refers to graphenic carbon particles where organic groups are covalently bonded to the graphenic carbon particles. The graphenic carbon particles can be functionalized through the formation of covalent bonds between the carbon atoms of a particle and other chemical moieties such as carboxylic acid groups, sulfonic acid groups, hydroxyl groups, halogen atoms, nitro groups, amine groups, aliphatic hydrocarbon groups, phenyl groups and the like. For example, functionalization with carbonaceous materials may result in the formation of carboxylic acid groups on the graphenic carbon particles. Graphenic carbon particles may also be functionalized by other reactions such as Diels-Alder addition reactions, 1,3-dipolar cycloaddition reactions, free radical addition reactions and diazonium addition reactions. Hydrocarbon and phenyl groups may be further functionalized. For graphenic carbon particles having a hydroxyl functionality, the hydroxyl functionality can be modified and extended by reacting these groups with, for example, an organic isocyanate.

Different types of graphenic carbon particles may be used in a composition.

A coreactive composition can comprise, for example, from 2 wt % to 50 wt %, from 4 wt % to 40 wt %, from 6 wt % to 35 wt %, or from 10 wt % to 30 wt % thermally produced graphenic carbon particles, where wt % is based on the total weight of the coreactive composition.

Filler used to impart electrical conductivity and EMI/RFI shielding effectiveness can be used in combination with graphene.

Electrically conductive non-metal filler, such as carbon nanotubes, carbon fibers such as graphitized carbon fibers, and electrically conductive carbon black, can also be used in coreactive compositions in combination with graphene.

Examples of suitable carbonaceous materials for use as conductive filler other than graphene and graphite include, for example, graphitized carbon black, carbon fibers and fibrils, vapor-grown carbon nanofibers, metal coated carbon fibers, carbon nanotubes including single- and multi-walled nanotubes, fullerenes, activated carbon, carbon fibers, expanded graphite, expandable graphite, graphite oxide, hollow carbon spheres, and carbon foams.

A filler can include carbon nanotubes. Suitable carbon nanotubes can be characterized by a thickness or length, for example, from 1 nm to 5,000 nm. Suitable carbon nanotubes can be cylindrical in shape and structurally related to fullerenes. Suitable carbon nanotubes can be open or capped at their ends. Suitable carbon nanotubes can comprise, for example, more than 90 wt %, more than 95 wt %, more than 99 wt %, or more than 99.9 wt % carbon, where wt % is based on the total weight of the carbon nanotube.

Carbon nanotubes can be provided as single-walled nanotubes (SWNT) and multi-walled nanotubes (MWNT), for example, as nanotubes having one single wall and nanotubes having more than one wall, respectively. In single-walled nanotubes a one atom thick sheet of atoms, for example, a one atom thick sheet of graphite, i.e., graphene, is rolled seamlessly to form a cylinder. Multi-walled nanotubes consist of a number of such cylinders arranged concentrically.

A multi-walled carbon nanotube can have, for example, on average from 5 to 15 walls.

Single-walled nanotubes can be characterized by a diameter of at least 0.5 nm, such as at least 1 nm, or at least 2 nm. A SWNT can have a diameter less than 50 nm, such as less than 30 nm, or less than 10 nm. A length of single-walled nanotubes can be at least 0.05 μm, at least 0.1 μm, or at least 1 μm. A length can be less than 50 mm, such as less than 25 mm.

Multi-walled nanotubes can be characterized by an outer diameter of at least 1 nm, such as at least 2 nm, 4 nm, 6 nm, 8 nm, or at least 9 nm. An outer diameter can be less than 100 nm, less than 80 nm, 60 nm, 40 nm, or less than 20 nm. The outer diameter can be from 9 nm to 20 nm. A length of a multi-walled nanotube can be less than 50 nm, less than 75 nm, or less than 100 nm. A length can be less than 500 μm, or less than 100 μm. A length can be from 100 nm to 10 μm. A multi-walled carbon nanotube can have an average outer diameter from 9 nm to 20 nm and/or an average length from 100 nm to 10 μm.

Carbon nanotubes can have a BET surface area, for example, from 200 m²/g to 400 m²/g. Carbon nanotubes can have a mean number of from 5 walls to 15 walls.

A coreactive composition can comprise one or more adhesion promoters.

An adhesion promoter can be selected to enhance substrate adhesion, interlayer adhesion, and/or adhesion to filler, reinforcing materials, and/or to other additives.

A coreactive composition can comprise an adhesion promoter or combination of adhesion promoters. Adhesion promoters can enhance the adhesion of a coating to an underlying substrate such as a metal, composite, polymeric, or a ceramic surface, or to a coating such as a primer coating or other coating layer. Adhesion promoters can enhance adhesion to filler and to other layers of a multilayer coating.

An adhesion promoter can include a phenolic adhesion promoter, a combination of phenolic adhesion promoters, an organo-functional silane, a combination of organo-functional silanes, or a combination of any of the foregoing. An organo-functional alkoxysilane can be an amine-functional alkoxysilane. The organo group can be selected from, for example, a thiol group, an amine group, an epoxy group, an alkenyl group, an isocyanate group, or a Michael acceptor group.

A phenolic adhesion promoter can comprise a cooked phenolic resin, an un-cooked phenolic resin, or a combination thereof. Examples of suitable adhesion promoters include phenolic resins such as Methylon® phenolic resin, and organosilanes, such as epoxy-, mercapto- or amine-functional silanes, such as Silquest® organosilanes. A cooked phenolic resin refers to a phenolic resin that has been coreacted with a monomer, oligomer, or prepolymer.

A phenolic adhesion promoter can comprise the reaction product of a condensation reaction of a phenolic resin with one or more thiol-terminated polysulfides. Phenolic adhesion promoters can be thiol-terminated.

Examples of suitable phenolic resins include 2-(hydroxymethyl)phenol, (4-hydroxy-1,3-phenylene)dimethanol, (2-hydroxybenzene trimethanol, 2-benzyl-6-(hydroxymethyl)phenol, (4-hydroxy-5-((2-hydroxy-5-(hydroxymethyl)cyclohexa-2,4-dien-1-yl)methyl)-1,3-phenylene)dimethanol, (4-hydroxy-5-((2-hydroxy-3,5-bis(hydroxymethyl)cyclohexa-2,4-dien-1-yl)methyl)-1,3-phenylene)dimethanol, and a combination of any of the foregoing.

Suitable phenolic resins can be synthesized by the base-catalyzed reaction of phenol with formaldehyde.

A phenolic adhesion promoter can comprise the reaction product of a condensation reaction of a Methylon® resin, a Varcum® resin, or a Durez® resin available from Durez Corporation with a thiol-terminated polysulfide such as a Thioplast® resin.

Examples of Methylon® resins include Methylon® 75108 (allyl ether of methylol phenol, see U.S. Pat. No. 3,517,082) and Methylon® 75202.

Examples of Varcum® resins include Varcum® 29101, Varcum® 29108, Varcum® 29112, Varcum® 29116, Varcum® 29008, Varcum® 29202, Varcum® 29401, Varcum® 29159, Varcum® 29181, Varcum® 92600, Varcum® 94635, Varcum® 94879, and Varcum® 94917.

An example of a Durez® resin is Durez® 34071.

A coreactive composition can comprise an organo-functional alkoxysilane adhesion promoter such as an organo-functional alkoxysilane. An organo-functional alkoxysilane can comprise hydrolysable groups bonded to a silicon atom and at least one organofunctional group. An organo-functional alkoxysilane can have the structure R¹²—(CH₂)ₙ—Si(—OR)₃₋ₙRₙ, where R¹³ is an organofunctional group, n is 0, 1, or 2, and R is alkyl such as methyl or ethyl. Examples of organofunctional groups include epoxy, amino, methacryloxy, or sulfide groups. An organo-functional alkoxysilane can be a dipodal alkoxysilane having two or more alkoxysilane groups, a functional dipodal alkoxysilane, a non-functional dipodal alkoxysilane or a combination of any of the foregoing. An organofunctional alkoxysilane can be a combination of a monoalkoxysilane and a dipodal alkoxysilane. For amino functional alkoxysilanes, R¹³ can be —NH₂.

Examples of suitable amino-functional alkoxysilanes under the Silquest® tradename include Silquest® A-1100 (γ-aminopropyltriethoxysilane), Silquest® A-1108 (γ-aminopropylsilsesquioxane), Silquest® A-1110 (γ-aminopropyltrimethoxysilane), Silquest® 1120 (N-β-(aminoethyl)-γ-aminopropyltrimethoxysilane), Silquest® 1128 (benzylamino-silane), Silquest® A-1130 (triaminofunctional silane), Silquest® Y-11699 (bis-(γ-triethoxysilylpropyl)amine), Silquest® A-1170 (bis-(γ-trimethoxysilylpropyl)amine), Silquest® A-1387 (polyazamide), Silquest® Y-19139 (ethoxy based polyazamide), and Silquest® A-2120 (N-β-(aminoethyl)-γ-aminopropylmethyldimethoxysilane).

Suitable amine-functional alkoxysilanes are commercially available, for example, from Gelest Inc, from Dow Corning Corporation, and Momentive.

An adhesion promoter can be a copolymerizable adhesion promoter. Copolymerizable adhesion promoters include adhesion promoters that have one or more functional groups reactive with one or more of the coreactants.

A coreactive composition can comprise, for example, from 1 wt % to 16 wt % of an adhesion promoter, from 3 wt % to 14 wt %, from 5 wt % to 12 wt %, or from 7 wt % to 10 wt % of an adhesion promoter or combination of adhesion promoters, where wt % is based on the total weight of the coreactive composition.

A coreactive composition can comprise less than 16 wt % of an adhesion promoter, less than 14 wt %, less than 12 wt %, less than 10 wt %, less than 8 wt %, less than 6 wt %, less than 4 wt % or less than 2 wt % of an adhesion promoter or combination of adhesion promoters, where wt % is based on the total weight of the coreactive composition.

A coreactive composition can further comprise a shelf stabilizer, a thermal stabilizer, a UV stabilizer, a UV absorber, a hindered amine light stabilizer, a dichroic material, a photochromic material, a polymerization moderator, a monomer having a single ethylenically unsaturated radially polymerizable group, a monomer having two or more ethylenically unsaturated radically polymerizable groups, a pigment, a dye, or a combination of any of the foregoing.

A coreactive composition provided by the present disclosure can comprise a shelf stabilizer or a combination of shelf stabilizers. Examples of suitable shelf stabilizers include 4-methoxyphenol, hydroquinone, pyrogallol, butylated hydroxytoluene (BHT), and 4-tert-butylcatechol.

A coreactive composition provided by the present disclosure can comprise a thermal stabilizer or a combination of thermal stabilizers.

Coreactive compositions provided by the present disclosure can comprise a UV stabilizer or a combination of UV stabilizers. UV stabilizers include UV absorbers and hindered amine light stabilizers. Examples of suitable UV stabilizers include products under the tradenames Cyasorb® (Solvay), Uvinul® (BASF), Tinuvin® (BASF).

A coreactive composition can comprise one or more rheology modifiers.

A rheology modifier is distinguished from other reactants and additives that influence the rheological properties of a coreactive composition. For example, the molecular weight of the coreactants, the backbone chemistry of the prepolymers, the amount of filler, and/or the type of filler can influence the rheological properties of a coreactive composition.

Rheology modifiers can be included to adjust the viscosity of the composition and to facilitate application.

Examples of suitable rheology modifiers include a combination of phthalates, terephathlic, isophathalic, hydrogenated terphenyls, quaterphenyls and higher or polyphenyls, phthalate esters, chlorinated paraffins, modified polyphenyl, tung oil, benzoates, dibenzoates, thermoplastic polyurethane plasticizers, phthalate esters, naphthalene sulfonate, trimellitates, adipates, sebacates, maleates, sulfonamides, organophosphates, polybutene, butyl acetate, butyl cellosolve, butyl carbitol acetate, dipentene, tributyl phosphate, hexadecanol, diallyl phthalate, sucrose acetate isobutyrate, epoxy ester of iso-octyl tallate, benzophenone and combinations of any of the foregoing.

A coreactive composition can comprise from 0.5 wt % to 7 wt % of a plasticizer or combination of plasticizers from 1 wt % to 6 wt %, from 2 wt % to 5 wt % or from 2 wt % to 4 wt % of a plasticizer or combination of plasticizers, where wt % is based on the total weight of the composition. Coreactive compositions can comprise less than 8 wt % plasticizer, less than 6 wt %, less than 4 wt %, or less than 2 wt % of a plasticizer or combination of plasticizers, where wt % is based on the total weight of the coreactive composition.

A coreactive composition can comprise a reactive diluent or combination of reactive diluents

Reactive diluents can also be used to modify the rheological properties of a coreactive composition.

Unlike rheology modifiers, a reactive diluent is capable of reacting with a coreactant with the terminal groups or with pendent functional groups.

A reactive diluent can be used to reduce the viscosity of the composition. A reactive diluent can be a low molecular weight compound having at least one functional group capable of reacting with at least one of the major reactants of the composition and become part of the cross-linked network. A reactive diluent can have, for example, one functional group, or two functional group. A reactive dilute can be used to control the viscosity of a composition or improve the wetting of filler in a composition.

For example, a coreactive composition can comprise a hydroxyl-functional vinyl ether or combination of hydroxyl-functional vinyl ethers.

A coreactive composition can comprise one or more colorants.

A coreactive composition can comprise pigments, dyes, or a combination thereof. Although colorants may not be suitable for use in actinic radiation-curable coreactive compositions to the extent that the colorants absorb some or all of incident actinic radiation, colorants can be used in coreactive compositions that are not curable using actinic radiation.

Examples of suitable inorganic pigments include metal-containing inorganic pigments such as those containing cadmium, carbon, chromium, cobalt, copper, iron oxide, lead, mercury, titanium, tungsten, and zinc. Examples include ultramarine blue, ultramarine violet, reduced tungsten oxide, cobalt aluminate, cobalt phosphate, manganese ammonium pyrophosphate and/or metal-free inorganic pigments. In particular embodiments the inorganic pigment nanoparticles comprise ultramarine blue, ultramarine violet, Prussian blue, cobalt blue and/or reduced tungsten oxide. Examples of specific organic pigments include indanthrone, quinacridone, phthalocyanine blue, copper phthalocyanine blue, and perylene anthraquinone.

Additional examples of suitable pigments include iron oxide pigments, in all shades of yellow, brown, red and black; in all their physical forms and grain categories; titanium oxide pigments in all the different inorganic surface treatments; chromium oxide pigments also co-precipitated with nickel and nickel titanates; black pigments from organic combustion (e. g., carbon black); blue and green pigments derived from copper phthalocyanine, also chlorinated and brominated, in the various alpha, beta and epsilon crystalline forms; yellow pigments derived from lead sulphochromate; yellow pigments derived from lead bismuth vanadate; orange pigments derived from lead sulphochromate molybdate; yellow pigments of an organic nature based on arylamides; orange pigments of an organic nature based on naphthol; orange pigments of an organic nature based on diketo-pyrrolo-pyrrole; red pigments based on manganese salts of azo dyes; red pigments based on manganese salts of beta-oxynaphthoic acid; red organic quinacridone pigments; and red organic anthraquinone pigments.

A colorant can be TiO₂. A coreactive composition can comprise, for example, from 1 wt % to 30 wt % TiO₂, from 5 wt % to 25 wt %, or from 10 wt % to 20 wt % TiO₂, where wt % is based on the total weight of the coreactive composition. A coreactive composition can comprise, for example, greater than 1 wt % TiO₂, greater than 5 wt %, greater than 10 wt %, greater than 15 wt %, greater than 20 wt %, or greater than 25 wt % TiO₂, where wt % is based on the total weight of the coreactive composition. A coreactive composition can comprise, for example, less than 30 wt % TiO₂, less than 25 wt %, less than 20 wt %, less than 15 wt %, or less than 10 TiO₂, where wt % is based on the total weight of the coreactive composition. The TiO₂ can comprise a silica coating. The TiO₂ can have a mean particle size, for example, from 200 mm to 600 mm, such as from 200 mm to 500 mm.

A coreactive composition can comprise one or more photochromic agents.

A coreactive composition can comprise a photochromic agent sensitive to surface degradation mechanisms exposure to actinic radiation. Photochromic agents can facilitate the ability to detect and quantify damage of the multilayer coating.

A photochromic material can be activated by absorbing radiation energy (visible and non-visible light) having a particular wavelength, such as UV light, to undergo a feature change such as a color change. The feature change can be a change of feature of the photochromic material alone or it can be a change of feature of a coreactive composition. Examples of suitable photochromic materials include spiropyrans, spiropyrimidines, spirooxazines, diarylethenes, photochromic quinones, azobenzenes, other photochromic dyes and combinations thereof. These photochromic materials can undergo a reversible or irreversible feature change when exposed to radiation where the first and second states can be different colors or different intensities of the same color.

Examples of suitable photochromic agents include spiropyrans. Spiropyrans are photochromic molecules that change color and/or fluoresce under different wavelength light sources. Examples of suitable photochromic spiropyrans include 1′,3′-dihydro-8-methoxy-1′,3′,3′-trimethyl-6-nitrospiro[2H-1-benzopyran-2-,2′-(2H)-indole]; 1′,3′-dihydro-1′,3′,3′-trimethyl-6-nitrospiro[2H-1-benzopyran-2,2′-(2H)-indole]; 1,3-dihydro-1,3,3-trimethylspiro[2H-indole-2,3′-[3H]naphth[2,1-b][1,4]oxazine]; 6,8-dibromo-1′,3′-dihydro-1′,3′,3′-trimethylspiro[2H-1-benzopyran-2,2′-(2H)-indole]; 5-chloro-1,3-dihydro-1,3,3-trimethylspiro[2H-indole-2,3′-[3H]phenanthr[9,-10-b][1,4]oxazine]; 6-bromo-1′,3′-dihydro-1′,3′,3′-trimethyl-8-nitrospiro[2H-1-benzopyran-2,2-′-(2H)-indole]; 5-chloro-1,3-dihydro-1,3,3-trimethylspiro[2H-indole-2,3′-[3H]naphth[2,1-b-][1,4]oxazine]; 1′,3′-dihydro-5′-methoxy-1′,3,3-trimethyl-6-nitrospiro[2H-1-benzopyran-2,-2′(2H)-indole]; 1,3-dihydro-1,3,3-trimethylspiro[2H-indole-2,3′-[3H]phenanthr[9,10-b][1,4-]oxazine]; 5-methoxy-1,3,3-trimethylspiro[indoline-2,3′-[3H]naphtha[2,1-b]-pyran]; 8′-methacryloxymethyl-3-methyl-6′-nitro-1-selenaspiro-[2H-1′-benzopyran-2,2′-benzoselenenazoline]; 3-isopropyl-8′-methacryloxymethyl-5-methoxy-6′-nitro-1-selenaspiro[2H-1′-benzopyran-2,2′-benzoselenazoline]; 3-isopropyl-8′-methacryloxymethyl-5-methoxy-6′-nitro-1-selenaspiro[2H-1′-benzopyran-2,2′-benzoselenazoline]; 8′-methacryloxymethyl-5-methoxy-2-methyl-6′-nitro-1-selenaspiro[2H-1′-benzopyran-2,2′-benzoselenazoline]; 2,5-dimethyl-8′-methacryloxymethyl-6′-nitro-1-selenaspiro[2H-1′-benzopyran-2,2′-benzoselenazoline]; 8′-methacryloxymethyl-5-methoxy-3-methyl-6′-nitrospiro[benzoselenazoline-2,2′(2′H)-1′-benzothiopyran]; 8-methacryloxymethyl-6-nitro-1′,3′,3′-trimethylspiro[2H-1-benzothiopyran-2,2′-indoline]; 3,3-dimethyl-1-isopropyl-8′-methacryloxymethyl-6′-nitrospiro-[indoline-2,-2′(2′H)-1′-benzothiopyran]; 3,3-dimethyl-8′-methacryloxymethyl-6′-nitro-1-octadecylspiro[indoline-2,2-′(2′H)-1′-benzothiopyran] and combinations thereof.

Azobenzenes are capable of photoisomerization between trans- and cis-isomers. Examples of suitable photochromic azobenzenes include azobenzene; 4-[bis(9,9-dimethylfluoren-2-yl)amino]azobenzene; 4-(N,N-dimethylamino)azobenzene-4′-isothiocyanate; 2,2′-dihydroxyazobenzene; 1,1′-dibenzyl-4,4′-bipyridinium dichloride; 1,1′-diheptyl-4,4′-bipyridinium dibromide; 2,2′,4′-trihydroxy-5-chloroazobenzene-3-sulfonic acid and combinations thereof.

Examples of suitable photochromic spirooxazines include 1,3-dihydro-1,3,3-trimethylspiro[2H-indole-2,3′-[3H]phenanthr[9,10-b](1,4-)oxazine]; 1,3,3-trimethyl spiro(indoline-2,3′-(3H)naphth(2,1-b)(1,4)oxazine); 3-ethyl-9′-methoxy-1,3-dimethylspiro(indoline-2,3′-(3H)naphth(2,1-b)(1,4)-oxazine); 1,3,3-trimethylspiro(indoline-2,3′-(3H)pyrido(3,2-f)-(1,4)benzoxazine); 1,3-dihydrospiro(indoline-2,3′-(3H)pyrido(3,2-f)-(1,4)benzoxazine) and combinations thereof.

Examples of suitable photochromic spiropyrimidines include 2,3-dihydro-2-spiro-4′-[8′-aminonaphthalen-1′(4′H)-one]pyrimidine; 2,3-dihydro-2-spiro-7′-[8′-imino-7′,8′-dihydronaphthalen-1′-amine]pyrimidine and combinations thereof.

Examples of suitable photochromic diarylethenes include 2,3-bis(2,4,5-trimethyl-3-thienyl)maleic anhydride; 2,3-bis(2,4,5-trimethyl-3-thienyl)maleimide; cis-1,2-dicyano-1,2-bis(2,4,5-trimethyl-3-thienyl)ethane; 1,2-bis[2-methylbenzo[b]thiophen-3-yl]-3,3,4,4,5,5-hexafluoro-1-cyclopentene; 1,2-bis(2,4-dimethyl-5-phenyl-3-thienyl)-3,3,4,4,5,5-hexafluoro-1-cyclopentene; stilbene; dithienylethenes and combinations thereof.

Examples of suitable photochromic quinones include 1-phenoxy-2,4-dioxyanthraquinone; 6-phenoxy-5,12-naphthacenequinone; 6-phenoxy-5,12-pentacenequinone; 1,3-dichloro-6-phenoxy-7,12-phthaloylpyrene and combinations thereof.

Other examples of suitable photochromic agents that can be used as cure indicators include ethylviolet and Disperse Red 177.

A coreactive composition provided by the present disclosure can include, for example, from 0.1 wt % to 10 wt % of a photochromic agent, such as from 0.1 wt % to 5 wt % or from 0.1 wt % to 2 wt %, where wt % is based on the total weight of the coreactive composition.

A coreactive composition can include a self-healing material. Examples of self-healing materials include mobile materials, tethered materials, and encapsulated materials.

Mobile and tethered materials can comprise groups capable of migrating to the surface of a multilayered article to restore desired surface properties. For example, mobile materials can be included in encapsulants or incorporated into an internal layer and can diffuse to the exterior surface to restore the surface properties. For example, the diffusion of hydrophobic materials to the surface can restore the hydrophobicity of the surface of a multilayer article.

A coreactive composition can comprise encapsulants. During degradation of an interior and/or external layer the encapsulants can release to release compounds capable of reacting with the damaged surface.

A coreactive composition can comprise one or more mobile or tethered compounds.

A mobile or tethered compound can be configured to migrate to the surface of the multilayer coating during use. A mobile compound refers to a compound that has a certain mobility with the cured polymer matrix such that the mobile compound can migrate to the surface of the multilayer coating during use. A tethered compound refers to a compound that is bound to the cured polymer matrix, and where a portion of the tethered compound can migrate through the cured polymer matrix to maintain and/or restore a surface property. The mobile or tethered compound can serve to continuously restored at least certain properties of the surface of the multilayer coating. For example, fluorinated compounds can be configured to migrate to the surface to maintain and/or restore the hydrophobicity of the surface. A mobile or tethered compound can be retained within an interior layer or be bound to the cured polymer within an interior layer.

A layer of an article provided by the present disclosure can independently comprise, for example, one or more reinforcing materials. The reinforcing material can be discrete reinforcement material or continuous reinforcing material

Filler included in a layer can function as a reinforcement. Filler generally refers to, for example, inorganic and organic materials in the form of particulates, nanomaterial, chopped fiber, or other material having a lower aspect ratio that serves to increase the tensile strength of the cured coreactive composition. The aspect ratio can be, for example less than 100:1, less than 80:1, less than 60:1, less than 40:1, less than 20:1, less than 10:1, less than 5:1, or less than 2:1. The aspect ratio can be, for example, greater than 1:1, greater than 2:1, greater than 5:1, greater than 10:1, greater than 20:1, greater than 50:1, or greater than 100:1.

A coreactive composition can include a continuous reinforcement material such as in the form of an inorganic or organic material in the form of a continuous structure such as a filament, fiber, tow, roving, twine, tape, mesh, woven mesh, fabric, or a combination of any of the foregoing. A continuous reinforcement material can be oriented with respect to the geometry of the article such as a wind turbine blade. A continuous reinforcement material can be provided along the longitudinal and/or orthogonal dimensions of a multilayer article. A continuous reinforcement can be coextruded with the materials forming a multilayer article and can be included in one or more of the layers forming the article.

Examples of suitable inorganic continuous reinforcement include glass, ceramic, metal, carbon, graphite, graphene, and combinations of any of the foregoing.

Examples of suitable organic continuous reinforcement include polymeric fiber, natural fiber, synthetic fiber, or a combination of any of the foregoing.

Examples of metal fiber include steel, titanium, aluminum, gold, silver, and alloys of any of the foregoing.

Examples of suitable ceramic fiber include metal oxide such as alumina fibers, aluminasilicate fibers, boron nitride fibers, silicon carbide fibers, and combinations of any of the foregoing.

Examples of suitable inorganic fiber include carbon, alumina, basalt, calcium silicate, and rock wool.

A continuous reinforcement can be a glass fiber such as S-glass fibers, E-glass fibers, soda-lime-silica fibers, basalt fibers, or quartz fibers. Glass fiber may be in the form of woven and/or braided glass fibers, or non-woven glass fibers.

A continuous reinforcement can include carbon such as graphite fibers, glass fibers, ceramic fibers, silicon carbide fibers, polyimide fibers, polyamide fibers, or polyethylene fibers. Continuous fibers can comprise titanium, tungsten, boron, shape memory alloy, graphite, silicon carbide, boron, aramid, poly(p-phenylene-2,6-benzobisoxazole), and combinations of any of the foregoing.

Fiber capable of withstanding high temperature include, for example, carbon fiber, high-strength glass (SiO₂) fiber, oxide fiber, alumina fiber, ceramic fiber, metal fiber, and fibers of high temperature thermoplastics or thermosets.

In should be appreciated that the amount of conductive material used in a multilayer article, whether in the form of a continuous reinforcement or as a conductive filler can be limited by the propensity of conductive elements in a leading edge of a wind turbine blade to accelerate damage due to lightning strikes.

Suitable continuous reinforcement includes fiber having a diameter, for example, within a range from 100 nm to 150 μm, from 1 μm to 100 μm, from 1 μm to 90 μm, from 1 μm to 50 μm, from 5 μm to 40 μm, from 5 μm to 30 μm, from 10 μm to 30 μm, or from 1 μm to 20 μm.

Continuous reinforcement can be introduced into the coextrusion using pultrusion methods.

A single layer or multilayer article provided by the present disclosure can be fabricated using reactive additive manufacturing methods. In coreactive additive manufacturing a composition having coreactive components is extruded through a nozzle. A coreactive composition can be a one-part composition in which the reaction between the reactants is initiated by an external source of energy. For example, the reaction in a one-part composition can be initiated by actinic radiation such as UV, by heat, by mechanical forces, such as by shear force. The reaction can also be initiated by atmospheric moisture. A coreactive composition can be a two-part composition in which the coreactants are provided as separate components that are combined and mixed before extruding through a nozzle. The coreactants can react at ambient conditions such as at 25° C. The reaction rate can be modified by using suitable catalysts, cure retarders, and/or heat. A coreactive composition can comprise more than two components that can be combined and mixed before extrusion.

Reactive additive manufacturing includes coreactive three-dimensional printing.

Three-dimensional printing encompasses processes used to fabricate three-dimensional articles in which successive layers of material are formed under computer control, for example, using a three-dimensional primer or computer numerical control (CNC) device having one or more extruders to create the article. Articles can be produced from digital model data. Three-dimensional printing includes methods that encompass depositing layers in three dimensions such as that curved shapes can be fabricated.

In the context of fabricating multilayer articles provided by the present disclosure, three-dimensional printing includes extruding a single layer or multiple layers through a nozzle having any suitable shape such as an elongated nozzle assembly where the layers forming the multilayer coating are coextruded together as a single extrudate. In principle, the extrusion assembly can have the same width as that of the finished article. For example, to fabricate a single layer or a multilayer leading edge protection shield, the extrusion assembly and extrudate can have a width from 1 m to 5 m and the multilayer shield can be fabricated as a single part. A single layer or multilayer article can also be extruded as sheets having a width less than that of the finished article. Successive layers of a single layer or a multilayer article can be deposited side by side to form the article such as a leading edge protection shield.

As another example, a single layer or multilayer article such as a wind turbine blade or a leading edge protection shield can be fabricated using additive manufacturing by extruding a substantially round extrusion.

Methods of fabricating a multilayer article provided by the present disclosure include depositing a multilayer article layer-by-layer. For example, an interior layer of a multilayer coating can be deposited by three-dimensional printing and a second layer such as an exterior layer can be deposited onto the interior layer. To expedite the fabrication process, the extrusion assembly can have an elongated shape, such as in the shape of a rectangular slit. Successive layers of a multilayer article can also be deposited layer by layer to build up the multilayer article such as a wind turbine blade or a leading edge protection shield.

Multilayer articles provided by the present disclosure such as wind turbine blades and leading-edge protection shields can be fabricated in various ways.

For a new wind turbine blade, a single layer or multilayer structure can be applied in conjunction with the fabrication of the blade or can be applied to a blade after at least a portion of the blade is fabricated. For example, the structural elements of a wind turbine blade and a leading edge protection shield can be fabricated separately. Each of the wind turbine blade structure and the leading edge protection shield can be fabricated using any suitable process. For example, a wind turbine blade structure can be fabricated using thermoforming methods, and a leading edge protection shield can be fabricated using three dimensional printing, or as another example, both the wind turbine blade and the leading edge protection shield can be fabricated using additive manufacturing processes provided by the present disclosure. For repair applications, a leading edge protection shield can be fabricated to have a desired shape to conform to the outer surface of a wind turbine blade, or the leading edge protection shield can be fabricated as a flexible sheet that can be applied onto the outer surface of a wind turbine blade and secured into place using an adhesive bonding layer.

During fabrication of a new blade, a multilayer article or a portion of a multilayer article can be applied to the surface of the mold cavity used to form the blade. For example, the exterior layer or layers of a wind turbine blade or a leading edge protection shield can be deposited into a mold cavity. The deposited multilayer article can be fully cured before application of the materials used to form the structural framework of the blade. Alternatively, the multilayer article can be deposited as a partially cured article that become fully cured during fabrication of the blade. A single layer or multilayer article can also be applied to the interior surface of the blade mold as an uncured composition or where at least certain layers are uncured. For example, an internal layer may remain uncured until application of an overlying structural layer is applied or curing of the internal layer of the multilayer coating may be initiated immediately before application of an overlying structural layer. Having the internal layer of the multilayer article cure while it is in contact with an overlying structural layer can increase the adhesion between the multilayer coating and the structural framework of the blade.

A wind turbine blade can be fabricated using coreactive additive manufacturing methods provided by the present disclosure. In addition to the exterior layer or layers of a wind turbine blade, one or more of the interior layers and/or internal layers of a wind turbine blade including one or more structural layers can be fabricated using reactive extrusion methods. The structural layers can include reinforcing materials such as reinforcing filler and/or continuous reinforcement material. The reinforcing materials can be combined with the coreactive compositions during the extrusion process or can be deposited or laid down on the multilayer assembly while layers are being deposited on in between the deposition of successive layers. The reinforcing material can be laid down in the form, for example, of filament, tape, or sheet. In addition, coreactive extrusion can be used to build in structural features into the layer. For example, one or more layers can include structures such as meshes having square, circular, cylindrical, hexagonal, or honey-comb patterns oriented orthogonal to the plane of a layer. These build in structures formed from either a flexible or rigid material can increase the mechanical properties of a wind turbine blade or a leading edge protection shield.

Rather than apply a single layer or multilayer article directly to the interior surface of the mold using additive manufacturing, a single layer or multilayer article can be provided as a flexible sheet that can be placed into the cavity of the blade mold in addition to the structural layers. The flexible sheet can be provided as sections that can fit onto the leading edge of a wind turbine blade. A flexible sheet can have properties suitable for use along different longitudinal locations along the wind turbine blade.

A single layer or multilayer article can be extruded to form a sheet of material that is uncured, partially cured, or fully cured. A single or multilayer article sheet can be formed on a backing substrate to facilitate handling. Rather than use a separate backing substrate that may or may not be removed before use, an exterior layer or layers of the multilayer article can be cured or partially cured to provide sufficient structural integrity to facilitate handling. A lift-off layer can be applied to a surface of the multilayer sheet to facilitate handling and to protect the surface prior to use. For example, a lift-off sheet can be applied to an adhesive layer that is removed prior to use. A single layer or multilayer article can comprise an adhesive layer configured to facilitate bonding of the article to exterior surface of a wind turbine blade such as the leading edge of the wind turbine blade.

A single layer or multilayer sheet can be placed into a mold cavity for a wind turbine blade as appropriate. A multilayer sheet can be applied to the entire blade or at selected portions of the blade such as the leading edge of the wind turbine blade.

Applying a single layer or multilayer sheet to the structural components of a wind turbine blade in a mold cavity can facilitate the ability to obtain an aerodynamically smooth exterior surface.

Before being placed in a blade mold cavity, a single layer or multilayer article can be provided as a preformed component that conforms to the shape of the blade mold cavity or portion of the blade mold cavity in which it is to be placed.

A preformed single layer multilayer article can be fabricated using additive manufacturing to deposit single layer and multiple layers onto a structure having a desired shape. For example, the shape can be that of a portion of the exterior surface of a blade. A single layer or multilayer article can be applied to the surface of the structure and partially or fully cured in place. The single layer or multilayer shell can then be inserted into the blade mold cavity and integrated into the blade as part of the blade fabrication process.

A preformed single layer and multilayer article can also be fabricated by first forming a flexible sheet. The flexible sheet can be uncured or at least partially cured. The flexible sheet can be placed over the exterior mold and cured in place to provide a multilayer preform

Single layer and multilayer articles provided by the present disclosure can also be used to repair damaged wind turbine blades. Methods provided by the present disclosure can be used to repair a damaged wind turbine blade while the blade is mounted to the turbine and can be used to repair a damaged wind turbine blade after the damaged wind turbine blade

Damaged wind turbine blades can be repaired while the blades are mounted on the turbine or can be removed and repaired after being removed from the turbine.

Before applying a single layer or multilayer article to a damaged blade, the damaged surface can be cleaned. Any suitable method can be used to clean the damaged surface including, for example, mechanical abrasion such as blasting with particulates or sanding, solvent treatment, and/or plasma treatment such as exposure to a plasma such as an O₂ plasma. An objective of the cleaning process is to provide a surface that has acceptable adhesion to the article. Depending on the adhesives used to bond the r article such as leading edge protection shield to the damaged wind turbine blade, the surface may be smooth or rough. It can also be desirable that the substrate surface not facilitate the retention of voids or air pockets when the single layer or multilayer article is applied to the treated blade surface.

Without removing a wind turbine blade from the turbine or after removing a blade from a turbine, a single layer or multilayer article can be applied directly to the treated surface using coreactive additive manufacturing. A robotic arm can be used to guide an extrusion or coextrusion nozzle assembly over the treated surface and the applied single layer or multilayer article can be cured in place.

A single layer or multilayer article in the form of a shell can be used to repair a damaged blade either when the blade is mounted on a turbine or after a damaged wind turbine blade has been removed from the turbine.

A single layer or multilayer leading edge protection shell can have sufficient structural integrity to be handled, placed onto, and secured to the surface of a damaged blade.

A single layer or multilayer leading edge protection shell can have a longitudinal dimension, for example, from 1 m to 2 m, from 1 m to 4 m, from 1 m to 6 m, or from 1 m to 10 m. A multilayer leading-edge protection shell can have a length, for example, less than 10 m, less than 8 m, less than 6 m, less than 4 m, or less than 2 m. A single layer or multilayer leading edge protection shell can have a length, for example, greater than 1 m, greater than 2 m, greater than 4 m, greater than 6 m, greater than 8 m, or greater than 10 m.

A single layer or multilayer leading edge protection shell used for repair applications can be fabricated in a similar manner as described for fabricating a new blade. For example, coreactive additive manufacturing can be used to apply a single layer or multilayer article directly over a shaped substrate or to form a single layer or multilayer sheet that is subsequently shaped by applying to a shaped substrate. In either method, a compression operation can be applied to the article while the article is on the shaped substrate. The compression operation can serve to hide print lines, provide an aerodynamically smooth surface, refine the thickness of the article, and relieve stress generated during the fabrication operation.

Print lines resulting from the coreactive additive manufacturing process can be removed by abrasion or by applying a self-leveling coating to the multilayer article before or after the exterior layer of the article is cured. Alternatively, print lines resulting from the coreactive additive manufacturing process can be positioned during assembly such that the print lines face the interior of the part. The additional surface roughness or topography resulting from the print lines can improve adhesion to an adhesive bonding layer.

A multilayer leading edge protection shell can have a shape dimensions commensurate with that of the blade or portion of a blade that the shell is to be assembled on or applied to. More than one single layer or multilayer article or leading edge protection shell can be used to repair a damaged blade.

A leading edge protection shell can have an inner adhesive layer that is applied during the additive manufacturing process. A sheet of release material can be applied to the adhesive layer. The release layer can protect the adhesive layer and the release layer can be removed at the time the shell is applied to the blade. A single layer or multilayer article can be deposited onto a release layer during the additive manufacturing process. A release layer can be applied to the adhesive layer during the additive manufacturing process by coextruding the release layer along with the multiple coating layers. An adhesive layer can be applied to the article after it is formed and cured.

A leading edge protection shell may not include an adhesive layer, and the adhesive can be applied directly to a treated blade surface using any suitable method such as, for example, spraying, roller coating, or dry transfer.

A surface of a part fabricated using coreactive additive manufacturing can include print lines at the interface between successive layers. The print lines can be evident as raised features or as depressions. The density of the print lines can depend on the thickness of the individual layers used to form the part. For a multilayer coating, the density of print lines can be reduced by extruding the reactive composition through a nozzle having low aspect ratio, for example, a nozzle having a width that is greater than the thickness of the multilayer coating.

For a multilayer article, raised or depressed print lines can be configured to enhance the aerodynamic properties of the wind blades. For example, the print lines can be oriented along the longitudinal axis of a wind turbine blade, orthogonal to the longitudinal axis of a wind turbine blade, at an angle with respect to the longitudinal axis of a wind turbine blade, at a combination of angles with respect to a wind turbine blade, or a combination of any of the foregoing. The orientation of the print lines a vary as appropriate at different portions of the wind turbine blade. An article provided by the present disclosure can comprise print lines or the artifacts of print lines. For example, print lines may be evident as raised surface features and/or as interfacial areas in a cross-section of a single layer or multilayer article. The print lines or artifacts of print lines can be substantially orthogonal to the plane of a layer.

In certain applications, it can be desirable that a single layer or multilayer article be aerodynamically smooth, and therefore that the print lines have acceptably low dimensions.

The topography of the print lines can be minimized or removed by mechanically abrading the surface of a cured single layer or multilayer article. A thin topcoat can be applied to the abraded surface of the multilayer article to provide an aerodynamically smooth surface.

In an uncured state, print lines of a multilayer article can be removed by a compression molding process or at least by applying pressure to the uncured article sufficient to reform at least the surface of the single layer or multilayer article before the article fully cures. For example, pressure can be applied to a leading edge protection shield in an uncured or partially cured state to smooth the surface of the multilayer article. When formed as a single layer or multilayer sheet pressure can be applied to the sheet using a flat platen. When formed as a shaped multilayer article over a shaped substrate, pressure can be applied to a mated shaped substrate place over the shaped single layer or multilayer article.

Print lines can also be masked by applying a leveling coating to the exterior surface of the single layer or multilayer article. The use of coatings to hide additive manufacturing print lines is disclosed in PCT International Application No. PCT/US2019/26672 filed on Apr. 9, 2019, which is incorporated by reference in its entirety.

In another configuration, an article provided by the present disclosure can be fabricated using additive manufacturing to apply a coreactive composition onto a surface having acceptable surface properties such as to impart desirable properties to the exterior surface of the article.

Multiple leading edge protection shields can be applied to a new wind turbine blade or to repair a damaged wind turbine blade leading edge. In this case there can be gaps between adjacent shields after assembly onto the blades. The gaps can be filled by applying a coreactive composition between the gaps between the shields.

A leading edge protection shield can be a rigid, pre-shaped structure having an external aerodynamic profile matched to a desired or pre-determined leading edge profile of a wind turbine blade or a portion of a wind turbine blade. The shield can have an internal profile shaped to match the leading-edge or to match the profile of the leading edge following use.

A leading edge protection shield can be configured to cover the longitudinal length of a wind turbine blade, a substantial portion of the length of a wind turbine blade, or a portion of the wind turbine blade. Providing leading edge protection shields as a series of smaller sections having a length, for example from 1 m to 5 m, matched to a particular portion of the wind turbine blade, can facilitate handling and installation, as well as impart performance benefits.

The types and amount of damage to a turbine change along the longitudinal length of the blade and is at least in part associated with the increasing impact velocity toward the tip of the blade.

Smaller sections of leading edge protection shields can be designed to have a multilayer coating optimized to protect the blade at various locations along the length of the blade.

Each section can also have a thickness or range of thicknesses tailored to optimize the energy conversion efficiency and mechanical stability of the blade. For example, leading edge protection shields located toward the blade tip can be thinner than leading edge protection shields located toward the turbine nacelle. For example, an average thickness of a-n leading edge protection shield section can decrease from the nacelle toward the blade tip.

Before applying a leading edge protection shield to a damaged blade, the blade can be prepared to accept the leading edge protection shield. Preparing the damaged surface can including abrading the surface, solvent cleaning, and/or plasma treatment. The prepared surface can be smooth or can be rough, which can in part be determined by the type and viscosity of the adhesive used to bond the leading edge protection to the prepared blade surface.

Before assembling the leading edge protection shield to the blade surface an adhesive layer can be applied to the prepared surface and/or to the interior surface of the leading edge protection shield.

An innermost layer of the leading edge protection shield can be an adhesive layer that is covered with a release film. Immediately prior to assembly the release film can be removed to expose the adhesive layer and the leading edge protection shield with the exposed adhesive layer can be applied onto the prepared leading edge of the turbine blade and secured by pressing the leading edge protection shield onto the blade.

It can be desirable that the type and viscosity of the adhesive be selected and the method of assembling a leading edge protection shield onto a blade be designed to mitigate or prevent entrapment of voids and/or air bubbles at the adhesive interface. Voids and air bubbles can be nucleation sites for delamination caused, for example, -by thermal cycling and lightning strikes.

A leading edge protection shield can be designed to extend beyond the leading edge of a blade and have a thickness that tapers down toward the trailing-edge of the blade. A progressively reduced thickness or taper away from the leading edge of the blade can provide a smooth transition of the air flow onto the blade.

A leading edge protection shield can also be provided as a flexible sheet, sleeve, or cover that can be configured to fit tightly against the surface of the blade and secured to the blade using an adhesive or a connection that fits around the trailing-edge of the wind turbine blade. The flexible shield can be stretchable to facilitate the ability of the shield to conform to the profile of the wind turbine blade. The flexible shield can be in the form of a sleeve that can be configured to slip over the blade. A sleeve need not be secured to the blade using an adhesive but can be held against a wind turbine blade by elastic force.

An article provided by the present disclosure include wind turbine blades, portions of wind turbine blades, sections of wind turbine blades. An article can be a wind turbine blade in which the entire wind turbine blade or portions of a wind turbine blade is fabricated using additive manufacturing methods provided by the present disclosure, such as by three-dimensional printing. An article can be a leading edge protection shield that can be built into the wind turbine blade, applied to a wind turbine blade prior to use, or can be used to repair and restore wind turbine blades and in particular the leading edge of a wind turbine blade.

### ASPECTS OF THE INVENTION

The invention is further defined by the following aspects.

Aspect 1. An article fabricated using coreactive additive manufacturing, comprising: one or more interior layers, wherein each of the one or more interior layers independently comprises an interior layer coreactive composition; and an exterior layer overlying the first interior layer, wherein the first exterior layer comprises an exterior layer coreactive composition, wherein each of the one or more interior layers and the exterior layer is coextruded, wherein the article comprises a wind turbine blade, a portion of a wind turbine blade, a leading edge of a wind turbine blade, or a leading edge protection shield of a wind turbine blade.

Aspect 2. The article of aspect 1, wherein an innermost interior layer comprises an adhesive layer.

Aspect 3. The article of any one of aspects 1 to 2, wherein at least one of the one or more of the interior layers and the exterior layer comprises a structural layer.

Aspect 4. The article of any one of aspects 1 to 3, wherein the exterior layer is configured to be resistant to erosion by rain drops and/or particulates.

Aspect 5. The article of any one of aspects 1 to 4, wherein the exterior layer is configured to mitigate ice buildup.

Aspect 6 The article of any one of aspects 1 to 5, wherein the exterior layer is configured to mitigate accumulation of debris.

Aspect 7. The article of any one of aspects 1 to 6, wherein the exterior layer has one or more of the following properties:

a surface roughness (Rₐ) less than 0.3 μm

a distinctness of image (DOI) less than 90 GU at 60°, determined according to ISO 2813;

a drag coefficient less than 0.5;

a water contact angle greater than 90°;

a tan δ from 10 to 100, determined using an Anton Paar MCR 301 or 302 rheometer with a gap set to 1 mm, with a 25 mm-diameter parallel plate spindle, and an oscillation frequency of 1 Hz and amplitude of 0.3% at 25° C.;

a tensile strength greater than 15 MPa, determined according to ISO 527-3;

a tensile elongation greater than 400% at 400 mm/min, determined according to ISO 527-3;

impact resistance greater than 30 cm/kg, determined according to ASTM D27694;

pull-off strength greater than 5 MPa, determined according to ISO 4624;

flexibility greater than 1 mm, determined according to ISO 1519; and

a surface hardness from Shore 10A to Shore 60A, determined using a Type A durometer in accordance with ASTM D2240.

Aspect 8. The article of any one of aspects 1 to 7, wherein the article has one or more of the following properties:

a surface roughness (Rₐ) less than 0.3 μm

a distinctness of image (DOI) less than 90 GU at 60°, determined according to ISO 2813;

a drag coefficient less than 0.5;

a water contact angle greater than 90°;

a tan δ from 10 to 100, determined using an Anton Paar MCR 301 or 302 rheometer with a gap set to 1 mm, with a 25 mm-diameter parallel plate spindle, and an oscillation frequency of 1 Hz and amplitude of 0.3% at 25° C.;

a tensile strength greater than 15 MPa, determined according to ISO 527-3;

a tensile elongation greater than 400% at 400 mm/min, determined according to ISO 527-3;

impact resistance greater than 30 cm/kg, determined according to ASTM D27694;

pull-off strength greater than 5 MPa, determined according to ISO 4624;

flexibility greater than 1 mm, determined according to ISO 1519; and

a surface hardness from Shore 10A to Shore 60A, determined using a Type A durometer in accordance with ASTM D2240.

Aspect 9. The article of any one of aspects 1 to 8, wherein the article has a thickness greater than 500 μm.

Aspect 10. The article of any one of aspects 1 to 9, wherein each of the one or more interior layers and the exterior layer independently has a thickness from 1 μm to 1,000 μm.

Aspect 11. The article of any one of aspects 1 to 10, wherein the exterior coreactive composition comprises a polyurethane, a polyurea, a polyamine, a polyaspartic amine, a polyepoxide, a polysiloxane, a fluorinated polymer, or a combination of any of the foregoing.

Aspect 12. The article of any one of aspects 1 to 11, wherein one or more adjoining layers comprise coreactive compositions.

Aspect 13. The article of any one of aspects 1 to 12, wherein one or more adjoining layers comprise the same curing chemistry.

Aspect 14. The article of any one of aspects 1 to 13, wherein, each of the interior layer coreactive composition and the exterior layer coreactive composition independently comprises a first compound having one or more first functional groups and a second compound having one or more second functional groups; and the one or more first functional groups and the one or more second functional groups are coreactive.

Aspect 15. The article of any one of aspects 1 to 14, wherein each of the first compound and the second compound independently comprise a prepolymer, an adduct, a monomer, or a combination of any of the foregoing.

Aspect 16. The article of any one of aspects 1 to 15, wherein the one or more interior layers and the exterior layer independently comprises one or more additives.

Aspect 17. The article of any one of aspects 1 to 16, wherein the one or more interior layers and the exterior layer independently comprises one or more filler.

Aspect 18. The article of any one of aspects 1 to 17, wherein the one or more interior layers and the exterior layer independently comprises greater than 15 wt % inorganic filler.

Aspect 19. The article of any one of aspects 1 to 28, wherein the one or more interior layers and the exterior layer independently comprises one or more nanomaterials.

Aspect 20. The article of any one of aspects 1 to 19, wherein the one or more interior layers and the exterior layer independently comprises one or more hydrophobic surface modifiers.

Aspect 21. The article of any one of aspects 1 to 20, wherein the one or more interior layers and the exterior layer independently comprises a continuous reinforcement.

Aspect 22. The article of any one of aspects 1 to 21, wherein the one or more interior layers and the exterior layer independently comprises a mobile or tethered material.

Aspect 23. The article of any one of aspects 1 to 22, wherein at least one of the one or more interior layers and the exterior layer has a non-uniform thickness.

Aspect 24. The article of aspect 23, wherein each of the one or more interior layers and the exterior layer independently comprises a uniform thickness or a non-uniform thickness.

Aspect 25. The article of aspect 23, wherein the article has a non-uniform thickness.

Aspect 26. The article of aspect 25, wherein the non-uniform thickness varies in the longitudinal dimension.

Aspect 27. The article of any one of aspects 25 to 26, wherein the non-uniform thickness varies in the orthogonal dimension.

Aspect 28. The article of any one of aspects 25 to 26, wherein the non-uniform thickness varies in the longitudinal dimension and in the orthogonal dimension.

Aspect 29. The article of any one of aspects 1 to 28, wherein each of the one or more interior layers and the exterior layer independently comprises a structured layer or a non-structured layer.

Aspect 30. The article of claim 29, wherein each of the interior layers and the exterior layer is a non-structured layer.

Aspect 31. The article of aspect 29, wherein the non-structured layer comprises a substantially uniform coreactive composition.

Aspect 32. The article of aspect 29, wherein the structured layer comprises a non-uniform coreactive composition.

Aspect 33. The article of aspect 29, wherein at least one of the interior layers and the exterior layer is a structured layer.

Aspect 34. The article of aspect 33, wherein the structured layer comprises a vertically structured layer and/or a horizontally structured layer.

Aspect 35. The article of aspect 33, wherein the horizontally structured layer comprises a longitudinally structured layer and/or an orthogonally structured layer.

Aspect 36. The article of aspect 33, wherein the structured layer comprises a continuously structured layer or a dis-continuously structured layer.

Aspect 37. The article of any one of aspects 33 to 36, wherein the structured layer comprises differences in the constituents of the coreactive composition and/or the concentration of the constituents forming the coreactive composition within the structured layer.

Aspect 38. The article of any one of aspects 33 to 37, wherein the structured layer comprises differences in one or more properties within the structured layer.

Aspect 39. The article of any one of aspects 33 to 38, wherein each interface between adjacent layers independently comprises a structured interface or a non-structured interface.

Aspect 40. The article of any one of aspects 33 to 39, wherein the structured layer comprises discrete internal structures.

Aspect 41. The article of any one of aspects 1 to 40, wherein the article is uncured or partially cured.

Aspect 42. The article of any one of aspects 1 to 40, wherein the article is fully cured.

Aspect 43. The article of any one of aspects 1 to 42, wherein the article is in the form of a sheet.

Aspect 44. The article of any one of aspects 1 to 43, wherein the blade, leading edge or shield comprises a preform.

Aspect 45. A preform comprising the article of any one of aspects 1 to 44.

Aspect 46. The preform of aspect 45, wherein the preform is uncured or partially cured.

Aspect 47. The article of any one of aspects 1 to 44, wherein the article is a wind turbine blade.

Aspect 48. The article of any one of aspects 1 to 44, wherein the article is a portion of a wind turbine blade.

Aspect 49. The article of any one of aspects 1 to 44, wherein the article is a leading edge protection sheet.

Aspect 50. The article of any one of aspects 1 to 44, wherein the article comprises a wind turbine leading edge protection shield.

Aspect 51. The article of any one of aspects 1 to 44, wherein the article comprises a wind turbine leading edge protection shield preform.

Aspect 52. A wind turbine blade comprising one or more of the wind turbine leading edge protection shields of aspect 50.

Aspect 53. A wind turbine blade comprising one or more of the wind turbine blade leading edge protection shield preforms of aspect 51.

Aspect 54. A wind turbine blade comprising one or more of the wind turbine blade leading edge protection sheet of aspect 49.

Aspect 55. A method of fabricating the article of any one of aspects 1 to 44, comprising: combining the one or more interior layer coreactive compositions and the exterior layer coreactive composition in a coextrusion nozzle assembly; and coextruding the one or more interior layer coreactive compositions and the exterior layer coreactive composition through the extrusion nozzle assembly to form a multilayer article; or extruding a coreactive composition to form a single layer article.

Aspect 56. The method of aspect 55, further comprising, before combining in a coextrusion nozzle assembly, independently combining and mixing a first component comprising a first compound having one or more functional groups and a second component comprising a second compound having one or more second functional groups, to form the one or more interior layer coreactive compositions and the exterior layer coreactive composition, wherein the one or more first functional groups and the one or more second functional groups are coreactive.

Aspect 57. The method of any one of aspects 55 to 56, wherein coextruding or extruding comprises using additive manufacturing.

Aspect 58. The method of aspect 57, wherein additive manufacturing comprises three-dimensional printing.

Aspect 59. The method of any one of aspects 55 to 58, wherein the method comprises coextruding the multilayer article onto a release film or extruding the single layer article onto a release film.

Aspect 60. The method of any one of aspects 55 to 59, wherein the method comprises coextruding the multilayer article or extruding the single layer article onto an interior surface of a mold cavity.

Aspect 61. The method of any one of aspects 55 to 60, wherein the method comprises coextruding the multilayer article or extruding the single layer article onto a shaped substrate.

Aspect 62. The method of any one of aspects 55 to 61, wherein the method further comprises consolidating the coextruded multilayer article.

Aspect 63. The method of any one of aspects 55 to 62, wherein the method comprises coextruding the multilayer article to form a multilayer sheet or extruding the multilayer article to from a single layer sheet.

Aspect 64. A wind turbine blade, a portion of a wind turbine blade, a leading edge of a wind turbine blade, or a leading edge protection shield of a wind turbine blade prepared by the method of any one of aspects 55 to 63.

Aspect 65. A method of fabricating an article comprising the multilayer article of any one of aspects 1 to 44, comprising: placing a preform comprising the uncured or partially cured article of any one of aspects 1 to 44 into a mold cavity; placing a structural layer onto the preform; and consolidating the preform and the structural layer to form an article.

Aspect 66. The method of aspect 65, wherein the structural layer comprises a structural layer of a wind turbine blade.

Aspect 67. The method of aspect 65, wherein the structural layer comprises a wind turbine blade.

Aspect 68. An article fabricated using the method of claim 65.

Aspect 69. A method of fabricating an of any one of aspects 1 to 44, comprising extruding or coextruding the coreactive composition into a mold cavity; placing a structural layer onto the preform; and consolidating the preform and the structural layer to form an article comprising the article.

Aspect 70. An article fabricated by the method of aspect 69.

Aspect 71. A method of fabricating an article comprising, placing a preform comprising the extruded or coextruded article of any one of aspects 1 to 44 onto a shaped substrate; and consolidating the preform and the shaped substrate to form an article comprising the multilayer article.

Aspect 72. An article fabricated by the method of aspect 71.

Aspect 73. A method of fabricating an article, comprising extruding or coextruding the article of any one of aspects 1 to 44 into a shaped substrate; bonding the extruded or coextruded article to the shaped substrate to form an article comprising the multilayer article.

Aspect 74. An article fabricated by the method of aspect 73.

Aspect 75. A method of repairing a leading edge of a wind turbine blade, comprising: applying one or more leading edge protection shields of aspect 50 to a leading edge of a wind turbine blade; and bonding the one or more leading edge protection shields to the leading edge to repair the leading edge of the wind turbine blade.

Aspect 76. The method of aspect 75, wherein the leading edge protection shield comprises a single layer.

Aspect 77. The method of any one of aspects 75 to 76, wherein the method further comprises, before applying the leading edge protection shield, preparing the surface of the leading edge of the turbine blade.

Aspect 78. The method of aspect 77, wherein preparing comprises abrading, solvent cleaning, exposing to a plasma.

Aspect 79. The method of any one of aspects 77 to 78, wherein preparing comprises applying an adhesive layer to the leading edge protection shield and/or to the leading edge of the wind turbine blade.

Aspect 80. A wind turbine blade repaired by the method of any one of aspects 75 to 79.

Aspect 81. A method of repairing a leading edge of a wind turbine blade, comprising: coextruding the multilayer article onto a leading edge of a wind turbine blade; and bonding the multilayer article to the leading edge to repair the leading edge of the wind turbine blade.

Aspect 82. The method of aspect 81, wherein the leading edge protection shield comprises a single layer.

Aspect 83. A wind turbine blade repaired by the method of aspect 81.

Aspect 1A. A method of fabricating at least a portion of a wind turbine blade using coreactive additive manufacturing.

Aspect 2A. The method of aspect 1A, wherein the method comprises fabricating a wind turbine blade using coreactive additive manufacturing.

Aspect 3A. The method of aspect 1A, wherein the method comprises applying a leading edge protection layer to a leading edge of a wind turbine blade using coreactive additive manufacturing.

Aspect 4A. The method of aspect 1A, wherein the method comprises fabricating a leading edge protection shield using coreactive additive manufacturing.

Aspect 5A. The method of aspect 4A, wherein the leading edge protection shield comprises a preform.

Aspect 6A. The method of aspect 5A, wherein the preform is configured to conform to a shape of a leading edge of the wind turbine blade.

Aspect 7A. The method of aspect 4A, wherein the leading edge protection shield comprises a flexible sheet.

Aspect 8A. The method of aspect 4A, wherein the method further comprises bonding the leading edge protection shield to the leading edge of the wind turbine blade.

Aspect 9A. The method of any one of aspects 1A to 8A, wherein coreactive additive manufacturing comprises coreactive three-dimensional printing.

Aspect 10A. The method of any one of aspects 1A to 9A, wherein additive manufacturing comprises extruding a coreactive composition.

Aspect 11A. The method of aspect 10A, wherein the coreactive composition comprises a thermosetting composition.

Aspect 12A. The method of any one of aspects 10A to 11A, wherein the coreactive composition reacts at a temperature less than 50° C.

Aspect 13A. The method of any one of aspects 10A to 12A, wherein extruding comprises forming an extrudate having an inhomogeneous cross-sectional profile.

Aspect 14A. The method of any one of aspects 10A to 13A, wherein extruding comprises coextruding.

Aspect 15A. The method of aspect 14A, wherein coextruding comprises forming a multilayer extrudate.

Aspect 16A. A wind turbine blade, wherein at least a portion of the wind turbine blade is fabricated using the method of any one of aspects 1A to 15A.

Aspect 17A. The wind turbine blade of aspect 16A, wherein the portion of the wind turbine blade comprises a leading edge of the wind turbine blade.

Aspect 18A. The wind turbine blade of aspect 16A, wherein the leading edge comprises a leading edge protection layer applied using the method of any one of aspects 1A to 15A.

Aspect 19A. The wind turbine blade of aspect 18A, wherein the leading edge protection layer has a thickness from 0.1 mm to 3 mm.

Aspect 20A. The wind turbine blade of any one of aspects 18A to 19A, wherein the leading edge protection layer comprises a structured layer.

Aspect 21A. The wind turbine blade of any one of aspects 16A to 20A, wherein, the leading edge protection layer comprises a plurality of adjoining side-by-side deposits of the coreactive composition; and the adjoining layers are chemically bonded, physically bonded, or both chemically and physically bonded.

Aspect 22A. The wind turbine blade of aspect 16A, wherein the leading edge comprises a leading edge protection shield fabricated using coreactive additive manufacturing.

Aspect 23A. The wind turbine blade of aspect 22A, wherein the leading edge protection shield has a thickness from 0.1 mm to 3 mm

Aspect 24A. The wind turbine blade of any one of aspects 22A to 23A, wherein the leading edge protection shield comprises a structured layer.

Aspect 25A. The wind turbine blade of any one of aspects 22A to 24A, wherein, the leading edge protection shield comprises a plurality of adjoining side-by-side deposits of the coreactive composition; and the adjoining layers are chemically bonded, physically bonded, or both chemically and physically bonded.

Aspect 26A. The wind turbine blade of any one of aspects 22A to 25A, wherein a leading edge of the wind turbine blade is characterized by:

a gloss less than 90 GU at 60°, determined according to ISO 2813;

a surface roughness (Rₐ) less than 10 μm;

a water contact angle greater than 90°;

a diiodomethane contact angle greater than 50°;

a surface free energy less than 50 mN/m;

an impact force resistance greater than 90 inch-lb;

an abrasion weight loss less than 100 mg determined according to ASTM D4060;

a glass transition temperature less than −20° C.;

a tensile elongation greater than 400% determined according to ASTM D638;

a tensile strength greater than 2 MPa as determined according to ASTM D638 at 25° C.;

a Young's modulus greater than 1 MPa as determined according to ASTM D638 at 25° C.;

a storage modulus less than 200 MPa as determined at 25° C. and 100 MHz;

a storage modulus less than 1,000 MPa as determined at -25° C. and 158 MHz;

a rain erosion test value greater than 200 min as determined according to the method described in Example 3; or

a combination of any of the foregoing.

Aspect 27A. A leading edge protection shield fabricated using the method of any one of aspects 11A to 15A.

Aspect 28A. The leading edge protection shield of aspect 27A, wherein the leading edge protection shield has thickness from 0.1 mm to 3 mm.

Aspect 29A. The leading edge protection shield of any one of aspects 27A to 28A, wherein the leading edge protection shield comprises a structured layer.

Aspect 30A. The leading edge protection shield of any one of aspects 27A to 29A, wherein the leading edge protection shield is characterized by:

a gloss less than 90 GU at 60°, determined according to ISO 2813;

a surface roughness (Rₐ) less than 10 μm;

a water contact angle greater than 90°;

a diiodomethane contact angle greater than 50°;

a surface free energy less than 50 mN/m;

an impact force resistance greater than 90 inch-lb;

an abrasion weight loss less than 100 mg determined according to ASTM D4060;

a glass transition temperature less than −20° C.;

a tensile elongation greater than 400% determined according to ASTM D638;

a tensile strength greater than 2 MPa as determined according to ASTM D638 at 25° C.;

a Young's modulus greater than 1 MPa as determined according to ASTM D638 at 25° C.;

a storage modulus less than 200 MPa as determined at 25° C. and 100 MHz;

a storage modulus less than 1,000 MPa as determined at −25° C. and 158 MHz;

a rain erosion test value greater than 200 min as determined according to the method described in Example 3; or

a combination of any of the foregoing.

Aspect 31A. A method of repairing a leading edge of a wind turbine blade, comprising applying a leading edge protection layer to a damaged leading edge of a wind turbine blade using coreactive additive manufacturing.

Aspect 32A. A method of repairing leading edge of a wind turbine blade, comprising applying the leading edge protection shield of any one of claims 27A to 30A to a damaged leading edge of a wind turbine blade.

Aspect 33A. A wind turbine blade repaired by the method of any one of claims 31A and 32A.

Aspect 34A. A wind turbine blade comprising one or more layers, wherein at least one of the one or more layers comprises print lines.

Aspect 35A. The wind turbine blade of aspect 34A, wherein at least one of the one or more layers comprises a structured layer.

Aspect 36A. The wind turbine blade of aspect 35A, wherein the structured layer comprises a vertically structured layer, a horizontally structured layer or a combination thereof.

Aspect 37A. The wind turbine blade of any one of aspects 34A to 36A, wherein at least one of the one or more layers is chemically bonded, physically bonded, or both chemically and physically bonded to an underlying layer, to an overlying layer, or to both an underlying layer and an overlying layer.

Aspect 38A. The wind turbine blade of any one of aspects 34A to 37A, wherein adjoining layers have a relative fracture energy within less than 10% that of a single layer.

Aspect 39A. The wind turbine blade of any one of aspects 34A to 38A, wherein adjoining layers of the one or more layers has the same curing chemistry.

Aspect 40A. The wind turbine blade of any one of aspects 34A to 39A, wherein at least one of the one or more layers comprises a thermosetting composition.

Aspect 41A. The wind turbine blade any one of aspects 34A to 40A, wherein a leading edge of the wind turbine blade comprises the one or more layers.

Aspect 42A. The wind turbine blade any one of aspects 34A to 41A, wherein one of the one or more layers is characterized by:

a gloss less than 90 GU at 60°, determined according to ISO 2813;

a surface roughness (Rₐ) less than 10 μm;

a water contact angle greater than 90°;

a diiodomethane contact angle greater than 50°;

a surface free energy less than 50 mN/m;

an impact force resistance greater than 90 inch-lb;

an abrasion weight loss less than 100 mg determined according to ASTM D4060;

a glass transition temperature less than −20° C.;

a tensile elongation greater than 400% determined according to ASTM D638;

a tensile strength greater than 2 MPa as determined according to ASTM D638 at 25° C.;

a Young's modulus greater than 1 MPa as determined according to ASTM D638 at 25° C.;

a storage modulus less than 200 MPa as determined at 25° C. and 100 MHz;

a storage modulus less than 1,000 MPa as determined at -25° C. and 158 MHz;

a rain erosion test value greater than 200 min as determined according to the method described in Example 3; or

a combination of any of the foregoing.

### EXAMPLES

Embodiments provided by the present disclosure are further illustrated by reference to the following examples, which describe methods of fabricating a wind turbine blade leading edge protection layer using three-dimensional printing and certain properties of the leading edge protection layer. It will be apparent to those skilled in the art that many modifications, both to materials, and methods, may be practiced without departing from the scope of the disclosure.

### Example 1

### Coreactive Printing Leading Edge Protection Layer

Two coreactive printing compositions were used to fabricate a wind turbine blade leading edge protection layer.

The constituents used to form the coreactive compositions are provided in Table 1.

Coreactive printing Composition 1 was prepared using a two-part manganese dioxide-cured polysulfide Class B sealant, PR-1440, available from PPG Aerospace. Coreactive printing Composition 2 was prepared using an oligomeric diamine and a polycarbodiimide-modified diphenylmethane diisocyanate

TABLE 1
Constituents of Coreactive Compositions.

| | | |
|---|---|---|
| Material | Composition 1 | Composition 2 |

Part A

| | | |
|---|---|---|
| ¹ PR-1440 Class | 100 | 0 |
| B Sealant Part A | | |
| ² Versalink ® P 1000 | 0 | 96 |
| ³ Cabosil ® TS-720 | 0 | 4 |

Part B

| | | |
|---|---|---|
| ¹ PR-1440 Class | 100 | 0 |
| B Sealant Part B | | |
| ⁴ Isonate ® 143LP | 0 | 93 |
| Cabosil ® TS-720 | 0 | 7 |

Printing Composition

| | | |
|---|---|---|
| Mix Ratio A:B, vol/vol | 0.09:1 | 0.222:1 |

¹ PR-1440 Class B is a two-part, manganese dioxide cured polysulfide compounds, available from PPG Industries
² Versalink ® P 1000, oligomeric diamine, available from Evonik Industries.
³ Cabosil ® TS-720, fumed silica, commercially available from Cabot Corporation.
⁴ Isonate ® 143LP, polycarbodiimide-modified diphenylmethane diisocyanate, available from Dow Inc.

To fabricate leading edge protection layers, the Parts A and B of the respective coreactive printing compositions were transferred into separate Optimum® cartridges (available from Nordson) using a FlackTek SpeedDisc®.

The cartridges were mounted to a ViscoTec Duo dual extruder mounted to a computer-controlled three-dimensional printing gantry.

Using a nitrogen pressure of approximately 80 psi to 100 psi, the contents of the cartridges were independently pumped into the dual extruder. To prepare coreactive printing composition 1, Part A and Part B were combined in a 0.1:1 vol/vol ratio, and to prepare coreactive composition 2, Part A and Part B were combined in a 0.222:1 vol/vol ratio. The coreactive printing compositions were extruded from a static mixing nozzle onto a surface at a controlled print head speed, flow rate, and print fill pattern. The extrusion nozzle had a diameter of about 1 mm, the printing speed was within a range from about 2,000 mm/min to about 4,000 mm/min, and the flow rate was from about 2 mL/min to about 6 mL/min.

After printing, the leading edge protection layers were cured at 25° C. for more than 7 days before being tested.

The leading edge protection layers in the form of flexible sheets had a thickness of 0.7 mm.

### Example 2

### Properties of Printed Leading Edge Protection Layers

Various properties of the printed leading edge protection layers were determined. The results are summarized in Table 2, and the test procedures and discussions are in the following paragraphs.

(a) Measurement of Gloss and Surface Roughness.

The gloss of leading edge protection layers was measured using a 60 deg gloss meter manufactured by Byk-Gardner Instrument Company, and the Ra surface roughness value was measured using a Profilometer Surtronic Duo (Taylor Hobson).

(b) Water and Diiodomethane Contact Angle.

The contact angle of water and diiodomethane droplets on leading edge protection layers was determined using a Rame-Hart telephoto angle measuring instrument of Drop Shape Analyzer DSA100 (KRÜSS GmbH). The test samples were in a horizontal (non-tilted) position during measurements.

(c) Impact Force Resistance.

Impact force resistance was determined according to ASTM D2794 by subjecting test samples to various impacts from 10 in-lb to 90 in-lb impact. The impact force resistance was defined as the maximum force at which the test samples did not crack or break.

(d) Abrasion Resistance.

A modified ASTM D4060 was used to evaluate the abrasion resistance of the leading edge protection layers. Test samples having dimensions of 4 in×4 in were cut and mounted on the sample holder of a Model 5150 Taber Industries abraser. The abrasion resistance measurement was performed using CS-17 wheels. Each wheel bore a load of 1,000 gm. After every 500 cycles, the CS-17 wheel are reconditioned against S-11 refacing discs for 50 cycles. After 1,000 cycles, the mass loss of each test sample was measured. Pass/fail ratings are given for the test samples. A pass rating corresponded to a weight loss of less than 100 mg at the end of the test. Test samples having a weight loss greater than 100 mg were considered to have failed.

(e) Glass Transition Temperature.

The glass transition temperature (T_{g}) of the leading edge protection layers was determined by dynamic mechanical thermal analysis (DMA). The glass transition temperature was measured using a TA Instruments Q800 DMA Analyzer over a temperature range from −100° C. to 170° C. Rectangular test coupons were cut from the leading edge protection layers. The rectangular test coupons dimensions of 15 mm length×7 mm width. The DMA temperature was ramped at a rate 3° C./min, and with a frequency of 1 Hz and a clamping force of 20 cN/m using tension mode. The glass transition temperature was identified by the tan δ peak appearing immediately after the onset of the major depression in the storage modulus. Both leading edge protection layers exhibited a glass transition temperature below −20° C.

(f) Storage Modulus.

The storage modulus of the leading edge protection layers was also measured by DMA. The storage modulus of the leading edge protection layers at higher frequencies was determined by DMA using a frequency sweep at 25° C. at 100 Hz, and a frequency sweep at −25° C. at 158 Hz. The results are presented in Table 5. Both leading edge protection layers exhibited a storage modulus of less than 100 MPa at frequencies of 100 Hz and 158 Hz.

TABLE 2
Properties of printed leading edge protection layers.

| Property | Exp 13 | Exp 14 |
|---|---|---|
| Curing Chemistry | MnO₂-cured | Polyurea |
| | Polysulfide | |
| Gloss at 60 deg, ISO 2813, | 82 | 44 |
| Gloss Unit (GU) | | |
| Surface Roughness Rₐ, μm | 2.5 | 2.7 |
| Water Contact Angle, deg | 103 | 108 |
| Diiodomethane contact angle, deg | 84 | 84 |
| Impact Force Resistance, inch-lb | >90 | >90 |
| Abrasion Weight Loss, | Pass | Pass |
| ASTM D4060, Pass or Fail | | |
| Glass Transition Temperature | −33 | −43 |
| (Tg), Celsius | | |
| Tensile Elongation, ASTM D638, % | 526 | 1053 |
| Tensile Strength; 25° C., 175 μm, | 4 | 16 |
| ASTM D638, MPa | | |
| Tensile Young’s Modulus; 25° C., | 1.5 | 41.8 |
| ASTM D638, MPa | | |
| Storage Modulus; 25° C., | 13 | 36 |
| 100 Hz, MPa | | |
| Storage Modulus; −25° C., | 65 | 90 |
| 158 Hz, MPa | | |
| Rain Erosion Test (RET), min. | 270 | >480 |

### Example 3

### Rain Erosion Testing of Printed Wind Turbine Blade Shell

The rain erosion resistance of the leading edge protection layers bonded to an airfoil was determined using the following procedure.

Airfoil structures for the whirling arm test were prepared by applying the leading edge protection layers to epoxy-filled fiberglass airfoils. The surface of the airfoils was first conditioned by gently sanding the epoxy-filled fiberglass with P180 sandpaper and cleaning with a degreasing solution, DX 330 (PPG Industries). The solution was used to wet a cloth or paper towel, and the cloth was wiped across the exterior surface of the airfoil. The airfoil was then allowed to dry at ambient conditions (25° C./50% RH) for from 5 min to 10 min. An epoxy primer coating layer (CRE-121 available from PPG Industries) was applied using a hand-held HVLP spray gun to a dry film thickness from 102 μm to 203.2 μm (4-8 mils). The epoxy primer layer was allowed to dry at 25° C. for from 90 min to 120 min. A polyurethane topcoat layer (LT255 two-component polyurethane topcoat available from PPG Industries) was then applied to the airfoils using similar spray equipment to a dry film thickness from 76.2 μm to 254 μm (3-10 mils), and allowed to flash dry for from 10 min to 15 min. The airfoil with a polyurethane topcoat was then cured at 25° C. for 7 days.

Leading edge protection layers fabricated in Example 2 were trimmed to the size of the airfoil substrates. Before applying the leading edge protection layers, the polyurethane topcoat on the airfoils was gently sanded using P180 sand paper and wiped with DX 330 degreasing solution using a static mixer equipped with a spreader tip, 1 mm a polyurethane adhesive was applied onto the polyurethane topcoat on the airfoils. Immediately after applying the adhesive, a leading edge protection layer was aligned along the center line of the airfoil and manually pressed onto the airfoil substrates. The leading edge protection layer were applied to the adhesive with the surface having the print lines facing toward the airfoil. A low-density foam sponge and roller were used to smooth the leading edge protection layer and to press and remove excess adhesive at the edges of the leading edge protection layer. Excess adhesive was immediately removed with a spatula and the adhesive leading edge protection layer were allowed to cure for 7 days at 25° C.

The assembled airfoils were attached to a whirling arm apparatus. Samples were exposed to a 70 L/h water spray that had a droplet size from 1 mm to 4 mm. The whirling arm rotational velocity was 468 km/h (291 mph). The whirling arm apparatus was stopped at 15-minute intervals and the leading edge protection layer was visually inspected. The time to failure is defined as the time to when the leading edge protection layer exhibited erosion, which initially occurred at the tip. Without the leading edge protection layer, the polyurethane topcoat exhibited a time to failure of 120 minutes. With the leading edge protection layer, the time to failure was 270 minutes and at least 480 minutes, for layers prepared using Compositions 1 and 2, respectively.

Finally, it should be noted that there are alternative ways of implementing the embodiments disclosed herein. Accordingly, the present embodiments are to be considered as illustrative and not restrictive. Furthermore, the claims are not to be limited to the details given herein and are entitled to their full scope and equivalents thereof.

1-42. (canceled)

43. A method of fabricating at least a portion of a wind turbine blade using coreactive additive manufacturing, wherein coreactive additive manufacturing comprises:
combining and mixing two or more coreactive compounds to form a coreactive composition; and
extruding the coreactive composition to form a portion of a wind turbine blade.

44. The method of claim 43, wherein the method comprises fabricating a leading edge protection shield using coreactive additive manufacturing.

45. The method of claim 43, wherein coreactive additive manufacturing comprises coreactive three-dimensional printing.

46. The method of claim 43, wherein the coreactive composition comprises a thermosetting composition.

47. The method of claim 43, wherein the coreactive composition reacts at a temperature less than 50° C.

48. The method of claim 43, wherein extruding comprises forming an extrudate having an inhomogeneous cross-sectional profile.

49. The method of claim 43, wherein extruding comprises coextruding.

50. The method of claim 49, wherein coextruding comprises forming a multilayer extrudate.

51. The method of claim 43, wherein extruding comprises forming a structured layer.

52. The method of claim 51, wherein the structured layer comprises a vertically structured layer, a horizontally structured layer or a combination thereof.

53. The method of claim 43, comprising extruding two or more layers by coreactive additive manufacturing, wherein the layers are chemically bonded, physically bonded, or both chemically and physically bonded to an underlying layer, to an overlying layer, or to both an underlying layer and an overlying layer.

54. A wind turbine blade, wherein at least a portion of the wind turbine blade is fabricated using the method of claim 43.

55. The wind turbine blade of claim 54, wherein the portion of the wind turbine blade comprises a leading edge of the wind turbine blade.

56. The wind turbine blade of claim 54, wherein the portion of the wind turbine blade comprises a leading edge of the wind turbine blade comprises a leading edge protection layer.

57. The wind turbine blade of claim 56, wherein the leading edge protection layer comprises a structured layer.

58. The wind turbine blade of claim 57, wherein the structured layer comprises a vertically structured layer, a horizontally structured layer or a combination thereof.

59. The wind turbine blade of claim 54, wherein,
the leading edge protection layer comprises a plurality of adjoining side-by-side deposits of the coreactive composition; and
the adjoining layers are chemically bonded, physically bonded, or both chemically and physically bonded.
